(19) United States
(12) Patent Application Publication
(10) Pub. No.: US 2026/0231041 A1
(43) Pub. Date: Aug. 6, 2026

(54) SYSTEMS AND METHODS FOR DYNAMIC ASSET MONITORING AND POWER MANAGEMENT

(71) Applicant: Cisco Technology, Inc., San Jose, CA (US)

(72) Inventors: Niloofar Bahadori, Greensboro, NC (US); Ardalan Alizadeh, Campbell, CA (US); Peiman Amini, Fremont, CA (US); Jerome Henry, Pittsboro, NC (US)

(21) Appl. No.: 19/432,838

(22) Filed: Dec. 24, 2025

Related U.S. Application Data
(60) Provisional application No. 63/753,921, filed on Feb. 4, 2025.

(51) Int. Cl. H04W 52/02; H04W 4/029

(52) U.S. Cl. CPC H04W 52/0258; H04W 4/029

(57) ABSTRACT

Systems and methods for dynamic asset monitoring and power management in accordance with embodiments of the disclosure are described herein. An asset tracking device comprises a processor, a motion sensor, a network interface, and an asset monitoring logic that is configured to monitor a power metric associated with the asset tracking device and modify a sensor sampling parameter based on the power metric. The logic applies a linear interpolation algorithm to reconstruct data gaps resulting from reduced sampling frequencies. Furthermore, the logic determines a confidence metric associated with a motion state based on motion data captured by the sensor and activates a specific transmission mode selected from a plurality of transmission modes, such as Bluetooth Low Energy or Ultra-Wideband, based on the confidence metric satisfying a precision condition. Additionally, network devices may utilize environmental zones to determine configuration profiles that govern the sensitivity thresholds and monitoring behavior of the devices.

### PRIORITY

This application claims the benefit of and priority to U.S. Provisional Application No. 63/753,921, filed Feb. 4, 2025, which is incorporated in its entirety herein.

### FIELD

The present disclosure relates to systems and methods for dynamic asset monitoring and power management. More particularly, the present disclosure relates to systems and methods for utilizing hierarchical artificial intelligence models to dynamically configure sensor sampling, processing stages, and transmission modes within asset tracking devices to balance power consumption with tracking precision.

### BACKGROUND

Asset tracking systems are increasingly utilized across various industries, including healthcare, logistics, and manufacturing, to monitor the location and status of valuable equipment. These systems typically rely on small, battery-operated tracking devices attached to assets to provide visibility into their movement and usage within a facility. For example, in hospital environments, staff often need to locate medical devices quickly, while in warehouse settings, operators need to track the flow of inventory through the supply chain. The effectiveness of these deployments often hinges on the reliability and longevity of the tracking devices, particularly in large-scale environments where manual maintenance is labor-intensive.

A primary challenge in the deployment of such tracking systems is the management of power consumption relative to tracking precision. Because these asset tags are often deployed in large numbers and expected to operate for extended periods without maintenance, battery life is a critical operational metric. However, to maintain accurate real-time visibility, the tags must frequently wake up to sense motion or transmit location signals. Frequent transmission and sensor polling can rapidly deplete the device's energy reserves, leading to increased maintenance costs and operational disruptions associated with battery replacement. Conversely, aggressive power-saving measures can lead to periods of limited visibility, potentially causing the system to lose track of assets during critical movements.

Conventional approaches often utilize motion sensors that trigger transmission based on static acceleration thresholds. While effective for detecting basic movement, these static methods often struggle to differentiate between significant transport events and incidental environmental vibrations, such as those caused by nearby machinery or structural noise. Consequently, these devices may activate unnecessarily in response to minor vibrations, wasting power, or may fail to activate during smooth transport if the motion does not exceed the pre-set threshold.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual illustration depicting various subsets of artificial intelligence in accordance with various embodiments of the disclosure;

FIG. 2 are conceptual illustrations depicting different methods of machine-based learning in accordance with various embodiments of the disclosure;

FIG. 3 is a conceptual illustration depicting a machine learning lifecycle in accordance with various embodiments of the disclosure;

FIG. 4 is a conceptual illustration depicting an exemplary neural network in accordance with various embodiments of the disclosure;

FIG. 5 is a schematic conceptual illustration of a network deployment environment comprising various tracking devices, network infrastructure, and cloud services in accordance with an embodiment of the disclosure;

FIG. 6 is a conceptual illustration of a multi-access point topology configured for coordinated triggered uplink access in accordance with various embodiments of the disclosure;

FIG. 7 is a conceptual illustration of a physical environment utilizing context-aware zones to govern asset tracking sensitivity in accordance with various embodiments of the disclosure;

FIG. 8 is a conceptual illustration of a coverage map depicting overlapping sensor coverage zones for hybrid sensor polling in accordance with various embodiments of the disclosure;

FIG. 9 is a flowchart showing a process for hierarchical motion classification utilizing primary and secondary classification logic in accordance with various embodiments of the disclosure;

FIG. 10 is a flowchart showing a process for dynamic power and sensor management based on power metrics and confidence scores in accordance with various embodiments of the disclosure;

FIG. 11 is a flowchart showing a process for context-aware tracking and configuration profile determination in accordance with various embodiments of the disclosure;

FIG. 12 is a flowchart showing a process for predictive state transitioning based on motion signatures and historical data in accordance with various embodiments of the disclosure;

FIG. 13 is a flowchart showing a process for applying configuration-based filters based on identified object categories in accordance with various embodiments of the disclosure;

FIG. 14 is a flowchart showing a process for automated model refinement and environmental parameter monitoring in accordance with various embodiments of the disclosure; and

FIG. 15 is a conceptual block illustration for one or more devices capable of executing components and logic for implementing the functionality and embodiments described above.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

### Overview

In some embodiments, an asset tracking device includes a processor, a motion sensor configured to capture motion data, a network interface, and a memory communicatively coupled to the processor, wherein the memory includes an asset monitoring logic. The logic that is configured to monitor a power metric associated with the asset tracking device, modify a sensor sampling parameter based on the power metric, determine a confidence metric associated with a motion state of the asset tracking device based on the motion data, and activate a transmission mode based on the confidence metric satisfying a precision condition.

In some embodiments, a network device includes a processor, a network interface configured to communicate with a plurality of asset tracking devices, and a memory communicatively coupled to the processor, wherein the memory includes an asset monitoring logic. The logic is configured to identify an environmental zone associated with an asset tracking device, determine a configuration profile for the asset tracking device based on the environmental zone, analyze a motion trajectory against the configuration profile, and generate a notification in response to detecting a deviation from the configuration profile.

### EXAMPLE EMBODIMENTS

As a result, there is a continuous demand for improvements in how tracking devices manage sensor activity and power consumption to ensure reliable monitoring without compromising operational longevity. In response to the problems and issues described herein, embodiments of the present disclosure provide systems and methods for optimizing asset management through intelligent, context-aware tracking technologies. Specifically, the disclosure addresses the critical trade-off between maintaining high-precision visibility of assets and preserving the battery life of the tracking devices attached to them. Conventional systems often force a compromise, either rapidly draining batteries to ensure real-time tracking or sacrificing data granularity to extend operational longevity. Embodiments described herein overcome this limitation by introducing a hierarchical processing architecture that dynamically adjusts the behavior of the tracking device based on real-time environmental context and motion analysis. By utilizing onboard machine learning to filter out insignificant vibrations and only triggering high-power transmission modes, when necessary, the system ensures that assets are tracked with precision during critical events while conserving energy during periods of inactivity or routine transport.

Furthermore, the embodiments described herein introduce a multi-layered communication strategy that leverages both low-power protocols, such as Bluetooth Low Energy (BLE), and high-precision technologies, such as Ultra-Wideband (UWB). This hybrid approach allows the tracking device to maintain a constant, low-energy “heartbeat” connection for general presence monitoring while reserving high-energy ranging for scenarios that demand pinpoint accuracy. The system's ability to seamlessly switch between these modes is governed by an intelligent decision engine that evaluates confidence scores derived from sensor data. This ensures that the high-cost resources are only expended when the system determines that the value of the location data outweighs the energy cost, such as during unauthorized movement or entry into a restricted zone.

Additionally, the disclosure provides for a context-aware system that adapts its monitoring parameters based on the specific environment and the type of asset being tracked. By identifying unique zone identifiers or leveraging geospatial data, the tracking devices can automatically load configuration profiles that are optimized for their current location—be it a high-traffic loading dock or a quiet storage room. This adaptability extends to the asset level, where specific handling profiles can be applied to differentiate between fragile medical equipment and durable industrial machinery. This level of granularity minimizes false positives and ensures that the alerts generated by the system are actionable and relevant to the current operational context.

Moreover, the embodiments described herein facilitate predictive state transitioning by analyzing historical data and motion signatures to anticipate future actions. By recognizing patterns such as the rhythmic vibration of a forklift or the specific trajectory of a daily delivery route, the system can preemptively adjust its state to maintain continuity of tracking without waiting for a threshold breach. This predictive capability allows the system to “wake up” critical components just in time for a significant event, ensuring that no data is lost during the transition from a dormant to an active state. This proactive approach significantly enhances the reliability of the tracking data, providing a complete and unbroken record of the asset's movement history.

Finally, the disclosure addresses the need for continuous improvement and adaptation through automated model refinement. Recognizing that environmental conditions and asset behaviors can change over time, the system includes mechanisms for monitoring performance variance and updating the onboard machine learning models accordingly. Whether through localized self-tuning algorithms or centralized firmware updates, the tracking devices can evolve to maintain high accuracy in the face of shifting baselines, such as temperature fluctuations or new sources of background vibration. This ensures that the asset tracking solution remains robust and effective over the long term, reducing the need for manual recalibration and lowering the total cost of ownership for the deployment.

As those skilled in the art will recognize, Artificial Intelligence (AI) is a broad field within computer science focused on creating systems that can simulate aspects of human intelligence. These systems can range from simple rule-based programs to sophisticated models capable of learning, adapting, and making decisions based on data. AI spans various branches, including robotics, computer vision, natural language processing, and reinforcement learning, each aiming to enable machines to perform tasks that traditionally require human cognition. The potential of AI lies in its ability to enhance decision-making, improve efficiency, and even drive innovation across industries. With rapid advancements in computational power and algorithm design, AI is becoming increasingly embedded in our daily lives, powering applications from personal assistants to autonomous vehicles and even aiding in scientific research and complex problem-solving.

Machine learning (ML) is a crucial subset of AI that involves systems learning from data to make predictions or decisions without being explicitly programmed for each task. Unlike traditional software, which relies on hard-coded rules, machine learning systems use algorithms that identify patterns and adjust their behavior based on experience. ML includes various techniques, such as supervised learning, unsupervised learning, and reinforcement learning, each suited to different kinds of tasks. For example, supervised learning is commonly used in classification tasks, while reinforcement learning drives decision-making in dynamic environments. ML serves as the foundation for many modern AI applications, as it enables systems to generalize from data and improve over time. As such, ML systems are central to the development of more advanced AI models and applications, including those that require nuanced understanding, like image recognition and language processing.

Those skilled in the art will recognize that an asset tracking device, often referred to as an asset tag, can be understood as a small, battery-powered hardware unit designed to be physically attached to mobile or stationary equipment to monitor its location and status. These devices typically function by intermittently transmitting signals, such as unique identifiers or telemetry data, to a surrounding network infrastructure which then calculates the device's position. In many deployments, these tags are engineered with a primary focus on energy efficiency, utilizing sleep modes and low-power sensors to operate for multiple years without requiring battery replacement, thereby reducing the maintenance burden in large-scale facilities like hospitals or warehouses.

In various embodiments, these devices evolve beyond simple beaconing transmitters into intelligent edge computing nodes capable of processing environmental data locally. Modern asset tracking devices may incorporate microcontrollers with dedicated hardware accelerators that allow them to run machine learning inference algorithms directly on the device. This onboard intelligence enables the tag to distinguish between different types of motion events, such as the rhythmic vibration of a forklift versus the chaotic tumbling of a fall, allowing the device to make autonomous decisions about when to transmit data and which communication protocol to use, rather than relying solely on continuous, power-intensive streaming to a central server.

Often, Bluetooth Low Energy (BLE) can be understood as a wireless personal area network technology designed and optimized for applications requiring low power consumption and short-range communication. Unlike classic Bluetooth, which is designed for continuous data streaming applications like audio, BLE is intended for transmitting small amounts of data in short bursts, making it an ideal communication standard for battery-operated asset tags that need to periodically advertise their presence. The protocol utilizes a technique known as advertising, where the device broadcasts packets containing its identity and status on specific frequency channels, allowing scanning infrastructure devices like access points to detect the tag without establishing a full, energy-consuming connection.

In a number of embodiments, BLE serves as the default or “heartbeat” transmission mode for asset tracking systems due to its minimal energy impact. It is frequently utilized for determining proximity-based location, where the signal strength (Received Signal Strength Indicator or RSSI) of the broadcasted packet is measured to estimate the distance between the tag and the receiver. While this method provides a coarse location suitable for identifying which room or zone an asset is in, it allows the system to maintain general visibility of thousands of assets simultaneously without overwhelming the radio frequency spectrum or draining the device batteries.

Those skilled in the art will recognize that Ultra-Wideband (UWB) can be understood as a radio technology that can use a very low energy level for short-range, high-bandwidth communications over a large portion of the radio spectrum. Unlike narrowband systems that transmit via varying frequencies, UWB transmits data through the generation of radio energy at specific time intervals and occupying a large bandwidth, often employing pulse-position or time-modulation techniques. This distinct transmission method allows UWB signals to pass through obstacles like doors and partitions more effectively than other narrow-band signals, while also being highly resistant to interference from other wireless technologies sharing the airwaves.

In various embodiments, UWB is utilized specifically for its high-precision ranging capabilities, often achieved through Time-of-Flight (ToF) or Time-Difference-of-Arrival (TDoA) measurements. Because UWB pulses are extremely short in duration, receivers can determine the arrival time of the signal with high resolution, allowing for the calculation of the distance between the transmitter and receiver to within a few centimeters. This precision makes UWB the preferred mode for active tracking scenarios where knowing the exact location of an asset is critical, although it typically requires higher instantaneous power consumption compared to other low-power protocols.

Often, a Neural Network can be understood as a computational model inspired by the biological neural networks that constitute animal brains. Such systems “learn” to perform tasks by considering examples, generally without being programmed with task-specific rules. A neural network is based on a collection of connected units or nodes called artificial neurons, which loosely model the neurons in a biological brain. Each connection, like the synapses in a biological brain, can transmit a signal to other neurons. An artificial neuron that receives a signal then processes it and can signal neurons connected to it.

In a number of embodiments, these networks are organized into layers, comprising an input layer that receives raw data, one or more hidden layers that process the data through weighted connections, and an output layer that provides the final prediction or classification. In the context of asset tracking, a neural network might be trained on datasets of accelerometer readings to recognize complex patterns associated with specific movements. By adjusting the weights of the connections during a training phase, the network becomes capable of generalizing from these examples to correctly classify new, unseen motion data as specific events, such as a device being dropped or transported on a cart.

Those skilled in the art will recognize that a Decision Tree can be understood as a decision support tool that uses a tree-like model of decisions and their possible consequences, including chance event outcomes, resource costs, and utility. It is one way to display an algorithm that only contains conditional control statements. In machine learning, decision trees are used as a predictive model to go from observations about an item (represented in the branches) to conclusions about the item's target value (represented in the leaves). Tree models where the target variable can take a discrete set of values are called classification trees.

In various embodiments, decision trees are utilized as a primary, low-power classification stage because of their computational simplicity and interpretability. Unlike complex neural networks that require significant matrix multiplication, a decision tree can often be executed as a series of simple “if-then-else” comparisons, which consumes very little processor power. This makes them ideal for the initial “gating” logic on a battery-constrained device, where the system needs to quickly determine if a sensor reading warrants further, more expensive analysis or if it can be safely ignored.

Often, the Fast Fourier Transform (FFT) can be understood as a mathematical algorithm that computes the discrete Fourier transform (DFT) of a sequence, or its inverse. Fourier analysis converts a signal from its original domain (often time or space) to a representation in the frequency domain and vice versa. The FFT rapidly computes such transformations by factorizing the DFT matrix into a product of sparse (mostly zero) factors. As a result, it manages to reduce the complexity of computing the DFT, which allows for real-time signal processing on devices with limited processing power.

In a number of embodiments, FFT is employed as a feature extraction technique for raw sensor data, such as the stream of values coming from an accelerometer. By converting the time-series acceleration data into the frequency domain, the system can identify dominant vibration frequencies that are characteristic of specific mechanical sources, such as a motor humming or a wheel rattling. These frequency signatures serve as distinct features that can be fed into machine learning models, allowing the system to distinguish between noise and meaningful mechanical motion based on the spectral composition of the signal.

Those skilled in the art will recognize that Linear Interpolation can be understood as a method of curve fitting using linear polynomials to construct new data points within the range of a discrete set of known data points. It essentially involves drawing a straight line between two adjacent known values and estimating the value of a point at a specific location along that line. This technique is computationally efficient and simple to implement, making it a standard tool in digital signal processing for resampling data or filling in missing information without requiring complex higher-order mathematical functions.

In various embodiments, linear interpolation is utilized to reconstruct a usable motion profile from sensor data that was collected at a reduced sampling rate to save power. When a device lowers its polling frequency, it creates temporal gaps between sensor readings; linear interpolation allows the system to estimate the likely position or acceleration of the asset during those gaps. This reconstruction ensures that the tracking logic can still process a continuous stream of data for trajectory analysis or visualization, minimizing the loss of fidelity that would otherwise occur due to the aggressive power-saving measures.

In various embodiments, the memory is communicatively coupled to the processor, which is also coupled to the motion sensor, ensuring that all components are electronically coupled to process critical events effectively. When an asset falls from a specific height, the system detects the falling motion by comparing the acceleration data against a predetermined safety threshold. If the sensor readings indicate the asset falls outside the acceptable parameters during a fall, or if the battery level subsequently falls below a predetermined voltage limit, the logic generates a high-priority notification. To address potential data gaps caused by intermittent sampling, the system utilizes linear interpolation to reconstruct the missing data points, allowing the logic to accurately reconstruct the trajectory even where significant gaps exist. At least one predetermined condition must be met to trigger this specific notification, ensuring that alerts are only sent after a predetermined verification interval has passed.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.”. Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many other acquired instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.”. An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and acquired features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

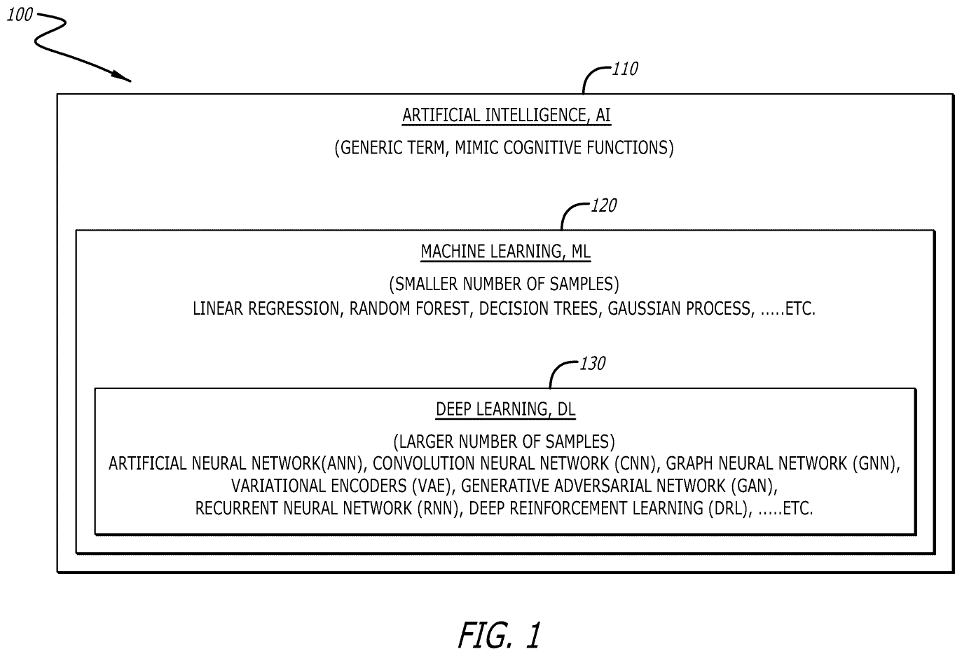

Referring to FIG. 1, a diagram 100 depicting various subsets of artificial intelligence in accordance with various embodiments of the disclosure is shown. Artificial intelligence (AI 110) is typically understood in the art to be the development of machines and algorithms that mimic human intelligence, for example, by optimizing actions to achieve certain goals. At its core, AI 110 often involves designing algorithms and models that mimic cognitive functions, such as learning, reasoning, problem-solving, perception, and even language understanding. Unlike traditional computer programs that follow a fixed set of instructions, AI systems have the ability to adapt, improve, and make decisions based on input data and environmental interactions.

AI 110 can be considered a generic term because it encompasses a wide range of subfields and techniques, from simple rule-based systems to advanced machine learning and deep learning models. These AI techniques are used to simulate various aspects of human cognition. For example, machine learning (ML 120) allows computers to learn from data patterns without explicit programming for each task, while natural language processing (NLP) enables machines to understand and generate human language. Deep learning (DL 130), a more advanced branch of AI, uses neural networks to automatically learn complex patterns from large datasets, akin to the human brain's information processing. This versatility makes AI a powerful tool across diverse applications, including image recognition, autonomous driving, voice assistants, healthcare diagnostics, and materials discovery.

A goal of AI is often to create systems that can function autonomously and intelligently in real-world scenarios. As AI 110 continues to evolve, it can increasingly mirror human-like cognition, enabling machines to not just process data but to “think” in a way that can handle uncertainty, make predictions, and even interact with their surroundings in a meaningful manner. While AI systems are far from achieving the full breadth of human intelligence, their ability to replicate specific cognitive functions makes them invaluable in tackling complex, data-driven challenges.

Machine Learning (ML 120) is a subset of Artificial Intelligence (AI 110) that focuses on the development of algorithms and statistical models that enable computers to learn and make decisions from data without explicit programming. In traditional programming, a computer is given a fixed set of rules to follow, but ML 120 can shift this paradigm by allowing systems to identify patterns, adapt, and improve their performance based on the data they encounter. This data-driven approach makes ML particularly valuable for tasks that are too complex or dynamic to define using straightforward rules, such as, for example, recognizing images, predicting consumer behavior, or diagnosing diseases. In various embodiments described herein, machine-learning methods may be utilized to classify motion events, manage power states, or optimize sensor sampling rates within an asset tracking device.

ML models can be configured to analyze large amounts of data to identify trends and relationships that inform their predictions or classifications. The process typically involves three stages: training, validation, and testing. During training, the model learns from a dataset by adjusting its internal parameters to minimize errors between its predictions and the actual results. Techniques like linear regression, decision trees, random forests, and Gaussian processes are commonly used in ML 120. These algorithms can handle various data types, including numerical, categorical, and structured datasets like spreadsheets or grids. One of the key strengths of ML is its ability to generalize from the training data to make accurate predictions on new, unseen data. In a number of embodiments described herein, training data may be generated from historical sensor data, manual tagging events, environmental feedback, among other sources.

However, traditional ML methods rely heavily on feature engineering, wherein human experts manually identify the most relevant features or patterns within the data. For example, when using ML 120 for image recognition, an expert might need to extract features like edges, textures, or color patterns before feeding them into a model. This requirement can limit the scalability of traditional ML approaches, especially when dealing with large, unstructured datasets such as images, text, or graphs. Additionally, ML algorithms may often work best when provided with relatively structured data, and they often need a reasonable amount of samples (typically more than one hundred) to learn effectively.

Deep Learning (DL 130) is a specialized subset of Machine Learning (ML 120) that employs multi-layered artificial neural networks to automatically learn complex patterns and representations from large, often unstructured datasets. Inspired by the way the human brain processes information, DL 130 consists of interconnected layers of “neurons” that can adaptively change as they are exposed to more data. Unlike traditional ML methods, which require manual feature engineering to identify key data characteristics, DL models can automatically extract features directly from raw data, such as images, text, or molecular structures. This automated feature extraction allows DL 130 to handle data types and tasks that were previously difficult or impossible for ML models to tackle effectively.

DL models, including Convolutional Neural Networks (CNNs), Graph Neural Networks (GNNs), and Recurrent Neural Networks (RNNs), excel at processing various forms of data. CNNs are particularly effective for image analysis, recognizing intricate patterns in visual inputs, making them indispensable in areas like materials science for analyzing microscopic images or detecting defects in materials. GNNs, on the other hand, are designed to work with graph-based data, such as molecular structures, social networks, or atomic interactions. They can learn the dependencies and relationships within graph-like structures, which is crucial for predicting properties of complex molecules and materials. RNNs and their variants, such as Long Short-Term Memory (LSTM) networks, are suited for sequential data like time series or natural language processing, allowing for the analysis and generation of textual information or the prediction of temporal patterns in scientific research.

One of the defining characteristics of deep learning is its requirement for large datasets (typically over five-hundred samples for example) to effectively train neural networks. The deep, multi-layered structure of these networks enables them to capture highly complex and abstract representations of the data, but it also demands significant computational power. Techniques like Variational Autoencoders (VAEs) and Generative Adversarial Networks (GANs) add to the versatility of DL by enabling the generation of new data samples that resemble the training set, aiding in areas such as materials discovery and synthetic data creation. Deep Reinforcement Learning (DRL) combines neural networks with decision-making processes to solve problems that involve optimization and control, further expanding DL's application potential. In summary, DL's ability to automatically learn from raw, unstructured data and model intricate patterns makes it a powerful tool in AI, particularly for complex domains like image recognition, natural language processing, and materials science.

Artificial Neural networks (ANNs or sometimes just NNs) are often a foundation of a DL system. The basic unit of a neural network is typically the perceptron, which can take inputs, assigns weights to these inputs, and combines them to produce an output. The final output is then passed through an activation function (such as, for example, ReLU, sigmoid, or hyperbolic tangent) to introduce non-linearity, which enables the network to model complex patterns.

Neural networks are typically trained through a process of backpropagation, where the system's predictions are compared against the known output, and a loss function is used to measure the difference between the prediction and the actual result. The network's weights can be adjusted through a process called gradient descent, which can be configured to minimize the loss function over time. However, the training process can be prone to problems like overfitting (where the model performs well on the training data but poorly on new data). To counter this, techniques such as regularization (e.g., regularization, dropout), early stopping, and mini batches can be utilized to prevent the network from becoming overly specialized to the training set.

CNNs are a specific type of ML 120 neural network designed to work particularly well with image data, making them highly relevant for analyzing complex vibration patterns or sensor signal graphs generated by the motion sensors. As those skilled in the art will recognize, CNNs typically use specialized layers known as convolutional layers, which apply filters (also known as kernels) to the input data. These filters slide over the input (e.g., an image), detecting patterns like edges or textures, which are then passed to the next layer for further processing. The advantage of CNNs is their ability to automatically learn and extract relevant features from raw data without the need for manual feature engineering. Furthermore, pooling layers (e.g., max-pooling or average pooling) are often added after convolutional layers to reduce the dimensionality of the data, helping to make the system more efficient while retaining the most important information. After several layers of convolutions and pooling, the CNN can output a prediction, such as classifying a motion event or generating a confidence score suitable for determining a transmission mode.

While CNNs are well-suited for grid-based data like images, many real-world problems in can involve non-grid data, such as asset locations, spatial relationships between assets and anchors, or asset movement trajectories. This type of data may better be represented as a graph, where nodes represent entities (e.g., tracking devices) and edges represent relationships between them (e.g., proximity or group movement). Thus, Graph Neural Networks (GNNs) can be utilized to operate on such graph-based data.

In GNNs, information is passed between nodes through edges in a process called message passing. This allows the network to capture dependencies and relationships within the graph structure. The key feature of GNNs is their ability to aggregate information from neighboring nodes, which is crucial in predicting properties that depend on the current/local structure, such as the behavior of an asset or the properties of a specific environmental zone.

Generative models aim to learn the underlying distribution of a dataset and generate new samples that resemble the original data. Two common types of generative models are Variational Autoencoders (VAEs) and Generative Adversarial Networks (GANs). VAEs are often configured to work by encoding data into a lower-dimensional latent space and then decoding it back into its original form. This allows for the generation of new data by sampling points from the latent space. This can be utilized when attempting to construct a potential vibration profile for anomaly detection or the like.

Similarly, GANs consist of two components: a generator that creates fake/generated data and a discriminator that tries to distinguish between real and fake data. The two components are trained in a competitive process where the generator tries to “fool” the discriminator, leading to increasingly realistic generated data. This type of process may be utilized to compare simulated motion data to realistic sensor outputs for robust model training.

Reinforcement Learning (RL) involves an agent learning to make decisions by interacting with an environment and receiving feedback (rewards or penalties) based on its actions. Deep Reinforcement Learning (DRL) combines RL with DL techniques, allowing agents to learn from high-dimensional inputs, such as images or complex simulations.

In asset tracking systems, DRL can be used in scenarios where an optimal decision needs to be made, such as optimizing a sensor sampling rate or finding the best configuration for a power state transition based on the desired or current properties of the battery. The combination of RL and DL can allow for learning from raw data, making it a powerful tool for dynamic and real-time decision-making within an asset tracking environment.

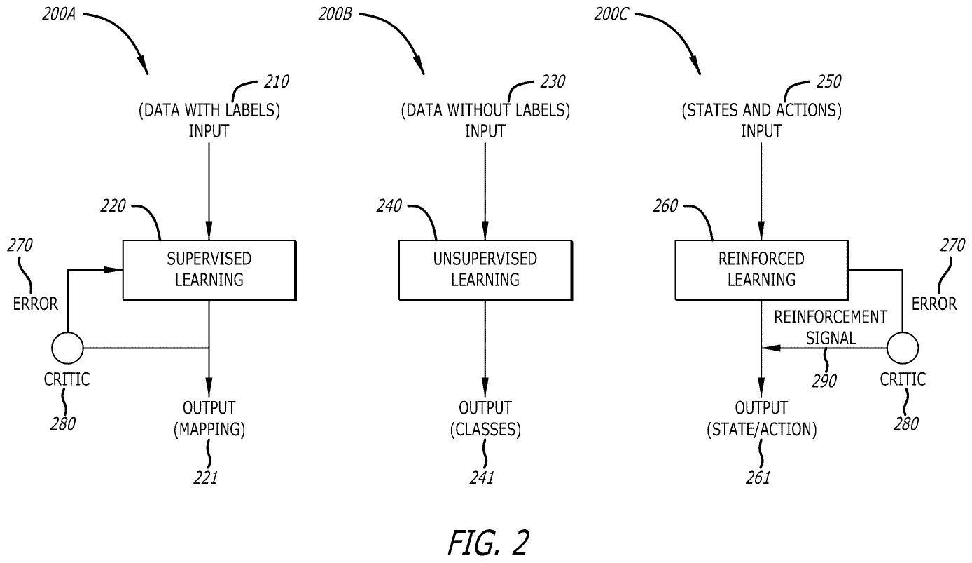

Although a specific embodiment for a diagram 100 depicting various subsets of artificial intelligence suitable for carrying out the various steps, processes, methods, and operations described herein is discussed with respect to FIG. 1, any of a variety of systems and/or processes may be utilized in accordance with embodiments of the disclosure. For example, other subset may be present and available for use within AI 110. Those skilled in the art will recognize that the diagram 100 presented in FIG. 1 is simplified for illustration purposes and various methods and techniques may interact with other areas (ML 120 with DL 130, etc.). The elements depicted in FIG. 1 may also be interchangeable with other elements of FIGS. 2-15 as required to realize a particularly desired embodiment.

Referring to FIG. 2, different methods of machine-based learning in accordance with various embodiments of the disclosure are shown. In many embodiments, a machine learning model is defined as a mathematical representation of the output of the training process. A machine learning model is often considered similar to computer software designed to recognize patterns or behaviors based on previous experience or data. However, the learning algorithm can discover patterns within the training data, and output an ML model which can capture these patterns and make predictions on new data.

ML models can be understood as a device that has been trained to find patterns within new data and make predictions. These models can be represented as a complex mathematical function that would be impractical for a human to calculate that takes requests in the form of input data, makes predictions on input data, and then provides an output in response. First, these models can be trained over a set of data, and then they are provided an algorithm or other task to reason over data, extract the pattern from feed data and learn from that data. Once the model(s) is/are trained, they can be used to predict a new and previously unseen dataset.

There are various types of machine learning models available based on different business goals and data sets available. Often, based on the desired application, ML models can be configured as or settle into one of three different model types: supervised learning, unsupervised learning, and/or reinforcement learning. Supervised learning can further be broken down into two categories of classification and regression. Likewise, unsupervised learning can be divided into three categories: clustering, association rule, and/or dimensionality reduction.

In the embodiment depicted in FIG. 2, a supervised learning system 200A is shown. The supervised learning system 200A can be configured with a supervised learning model 220 that accepts input data 210 and generates an output 221. However, the output data is often reviewed by a critic 280 that can determine one or more errors 270 that are fed back into the supervised learning model 220 via one or more reinforcement signals 290 for use in updating.

A supervised learning system 200A can often be considered the simplest machine learning model to understand in which input data (such as training data) has a known label or result as an output. So, the supervised learning model 220 can be understood to work on the principle of input-output pairs. As such, a function can be trained using a training data set, which is then applied to unknown data and makes some predictive performance. Supervised learning is task-based and mostly tested on labeled data sets.

A supervised learning system 200A may often involve one or more regression problems. In regression problems, the output is a continuous variable. Some commonly used Regression models include linear regression, decision trees, and random forests. Linear regression is typically the most straight forward machine learning model in which a prediction of one output variable is made using one or more input variables. The representation of linear regression can be processed as a linear equation, which combines a set of input values (denoted as x) and a predicted output (denoted as y) for the set of those input values. As those skilled in the art will recognize, this may be represented in the form of a line: Y=bx+c. A typical aim of a linear regression-based model can be to find the optimal fit line that best fits the available data points. Linear regression can be extended to multiple linear regressions (finding a plane of best fit in higher dimensional space) and polynomial regressions (finding the best fit curve). Decision trees are also popular machine learning models that can be used for both regression and classification problems. A decision tree uses a tree-like structure of decisions along with their possible consequences and outcomes. In this, each internal node is used to represent a test on an attribute while each branch is used to represent the outcome of the test. The more nodes a decision tree has, the more accurate the result will be. This may be used when making decisions related to whether a detected motion signature is indicative of a high-impact collision. The advantage of decision trees is that they are intuitive and easy to implement, but may lack accuracy depending on the available computational or time resources available.

Random forests are an ensemble learning method, which may consist of a large number of decision trees. For example, each decision tree in a random forest predicts an outcome, and the prediction with the majority of votes is considered as the outcome. A random forest model can be used for both regression and classification problems. For the classification task, the outcome of the random forest may be taken from the majority of votes. Whereas in the regression task, the outcome can be taken from the mean or average of the predictions generated by each tree.

Classification models are another type of supervised learning, which can be used to generate conclusions from observed values in one or more categorical forms. For example, a classification model can identify if an email is spam or not; whether a detected motion signature is indicative of a high-impact collision, etc. Classification algorithms can also be used to predict between two or more classes and/or categorize an output into different groups. For these classification systems, a classifier model can be designed that classifies the dataset into different categories, and each category can subsequently be assigned a label. As those skilled in the art will recognize, there are currently two main types of classifications in machine learning: binary and multi-class. Binary classification can be utilized when there are only two possible classes (i.e., yes/no, dog/cat, etc.). Multi-class classification can be utilized when there are more than two possible classes, thus requiring a multi-class classifier.

One of the potential classification processes is logistic regression. Logistic regression can be used to solve various classification problems in machine learning systems. These processes are similar to linear regression but are often used to predict categorical variables. While some variations can be configured to generate a prediction as an output in either “yes” or “no”, 0 or 1, “true” or “false”, etc. However, in some embodiments, the system can instead be configured to not give exact values, but instead provide probabilistic values between zero and one, etc.

Another classification process that can be utilized is a support vector machine (SVM) which is widely used for classification and regression tasks. However, the main aim of SVM is to find the best decision boundaries in an N-dimensional space, which can be utilized to segregate data points into classes, and generate a best decision boundary often known as a hyperplane. SVM processes can select the extreme vector to find a hyperplane, wherein these vectors are known as support vectors.

Naïve Bayes is another popular classification algorithm used in machine learning. This process receives its name as it is based on Bayes theorem and follows the naïve(independent) assumption between the features which is often given as the formula:

$$P ( y \vert X ) = ( P ( X \vert y ) * P ( y ) ) / ( P ( X ) )$$

This formula takes a class or target y and a predictor attribute (X) and calculates a posterior probability P(y|X) of that class given a particular predictor. P(y) is the prior probability of that class, P(X) is the prior probability of the predictor, and P(X|y) is the likelihood or probability of the predictor given the class. As those skilled in the art will recognize, this may be more succinctly understood as the posterior chance being a result of the prior results times the likelihood divided by the evidence available. Each naïve Bayes classifier assumes that the value of a specific variable is independent of any other variable/feature. For example, if a fruit needs to be classified based on color, shape, and taste. So yellow, oval, and sweet will be recognized as mango. Here each feature is independent of other features. Likewise, various embodiments herein can classify based on camera type, camera direction, point of interest present, etc.

Again, in the embodiment depicted in FIG. 2, an unsupervised learning system 200B is shown. The unsupervised learning system 200B can be configured with an unsupervised learning model 240 that accepts input data 230 and generates an output 241. Unlike other model types, there are no critics or error signals to process. An unsupervised learning model 240 can implement the learning process opposite to supervised learning, which means it enables the model to learn from an unlabeled training dataset. Based on the unlabeled dataset, the unsupervised learning model 240 can predict the output. Using an unsupervised learning system 200B, the unsupervised learning model 240 can learn hidden patterns from the dataset by itself without any supervision. In various embodiments, an unsupervised learning model 240 can often be utilized to perform tasks involving clustering, association rule learning, and/or dimensional reduction.

Clustering is an unsupervised learning technique that involves clustering or grouping the available data points into different clusters based on similarities and/or differences. The objects or data points with the most similarities remain in the same group, and they have no or very few similarities from other groups. Clustering algorithms can be used in a variety of different tasks such as, but not limited to image segmentation, statistical data analysis, market segmentation, and the like. Some commonly used clustering algorithms that can be selected include K-means Clustering, hierarchal Clustering, DBSCAN, etc.

Association rule learning is an unsupervised learning technique which finds unique relations among variables within a large data set. In many embodiments, a primary aim of this type of learning algorithm is to find the dependency of one data item on another data item and map those variables accordingly so that it can satisfy some desired outcome. For example, in certain embodiments, an association rule system may be utilized to identify a motion pattern that correlates with specific asset handling procedures. This algorithm can be applied in market basket analysis, web usage mining, continuous production, etc. However, those skilled in the art will recognize that other scenarios may be available based on the desired application. Some popular algorithms of association rule learning are Apriori Algorithm, Eclat, and FP-growth algorithm.

In additional embodiments, the number of features/variables present in a dataset can be understood as the dimensionality of the dataset, and the technique used to reduce the dimensionality is known as a dimensionality reduction technique. Although more data provides more accurate results, it can also affect the performance of the model/algorithm, such as yielding overfitting outcomes, etc. In such cases, dimensionality reduction techniques can be utilized. It is often desired that this process involves converting the higher dimensions dataset into lesser dimensions dataset while also ensuring that the ensuing results provide similar information. Different dimensionality reduction methods can be utilized, such as, but not limited to, PCA (Principal Component Analysis), Singular Value Decomposition (SVD), etc.

Finally, in the embodiment depicted in FIG. 2, a reinforcement learning system 200C is shown. The reinforcement learning system 200C can be configured with a reinforcement learning model 260 that accepts input data 250 and generates an output 261. In reinforcement learning, the reinforcement learning model 260 learns actions for a given set of states that lead to a goal state. In the embodiment depicted in FIG. 2, a critic 280 can receive or otherwise notice one or more errors 270 within the reinforcement learning model 260 actions, and adjust the outcome/output such that the “reward” or “punishment” is adjusted to better model the future behaviors or processing of the reinforcement learning model 260.

It is a feedback-based learning model that can take feedback signals after each state or action by interacting with the environment. This feedback works as a reward (positive for each good action and negative for each bad action), and the agent's goal is to maximize the positive rewards to improve their performance. The behavior of the model in reinforcement learning is similar to human learning, as humans learn things by experiences as feedback and interact with the environment. Popular methods of reinforcement learning including q-learning, state-action-reward-state-action (SARSA), and deep Q network.

Q-learning is one of the popular model-free algorithms of reinforcement learning, which is based on the Bellman equation. It often aims to learn the policy that can help the AI agent to take the best action for maximizing the reward under a specific circumstance. It can incorporate Q values for each state-action pair that indicate the reward to following a given state path, and it tries to maximize that Q-value.

SARSA is an on-policy algorithm based on the Markov decision process. In many embodiments, it can use the action performed by the current policy to learn the Q-value. The SARSA algorithm stands for State Action Reward State Action, which symbolizes the tuple (s, a, r, s′, a′). Finally, deep Q neural networking (or DQN) is Q-learning within a neural network. It can be deployed within a big state space environment where defining a Q-table would be a complex task. So, in these embodiments, rather than using a Q-table, the neural network instead utilizes Q-values for each action based on the state.

Although a specific embodiment for different methods of machine-based learning suitable for carrying out the various steps, processes, methods, and operations described herein is discussed with respect to FIG. 2, any of a variety of systems and/or processes may be utilized in accordance with embodiments of the disclosure. For example, those skilled in the art will recognize that methods of learning described herein are generalized and may incorporate other types developed as well as a combination of one or more methods based on the goals of the desired application. The elements depicted in FIG. 2 may also be interchangeable with other elements of FIGS. 1 and 3-15 as required to realize a particularly desired embodiment.

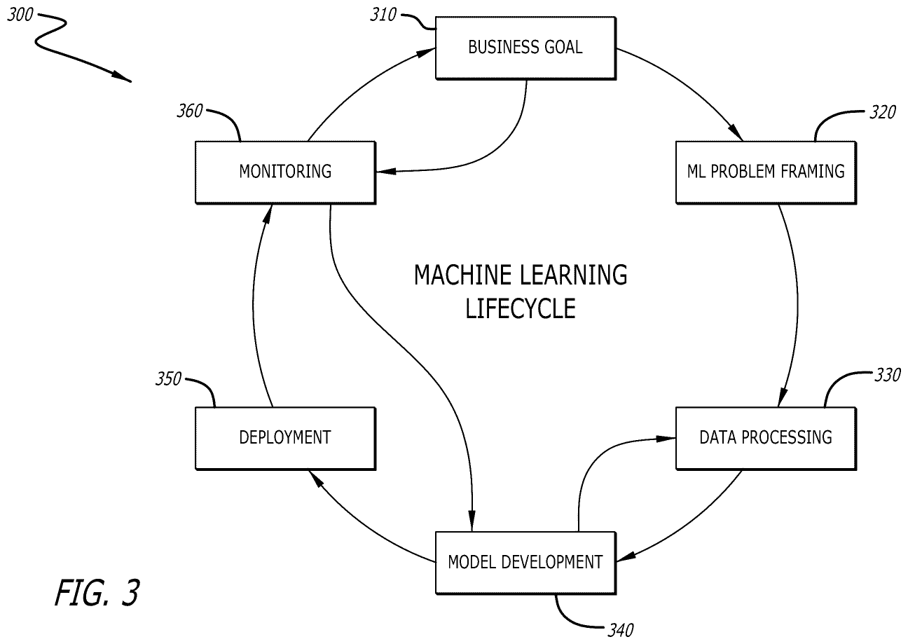

Referring to FIG. 3, a machine learning lifecycle 300 in accordance with various embodiments of the disclosure is shown. During the development of machine learning systems, the embodiment depicted in FIG. 3 can provide a framework for how to structure the design and maintenance of these systems. This machine learning lifecycle 300 outlines various stages involved in building, deploying, and improving ML models to solve real-world problems. By following this structured process, businesses and organizations can ensure that their machine learning projects align with strategic goals, use data effectively, and adapt to changing conditions over time. This machine learning lifecycle 300 emphasizes that developing a machine learning model is not a one-time effort but an iterative process requiring ongoing monitoring and adjustment. The feedback loop inherent in the machine learning lifecycle 300 allows for continual refinement and optimization of models to maintain their accuracy and relevance.

In many embodiments, a first stage of the machine learning lifecycle 300 is identifying the business goal 310, which sets the overall direction and purpose of the ML project. This can involve understanding the specific problems or opportunities within the business or project that machine learning can address. A business goal 310 that is clear can ensure that the project remains focused on delivering tangible value, whether it is extending battery life, optimizing tracking precision, predicting asset anomalies, or automating state transitions. Without a well-defined goal, it can be challenging to align the subsequent stages of the machine learning lifecycle 300, as the choice of model, data processing methods, and performance metrics can all depend on what the business aims to achieve.

Establishing a business goal 310 properly can also involve engaging with key stakeholders and developers to gather requirements and set success criteria. It can provide a roadmap that outlines what success looks like and helps in framing the ML problem. For example, if the goal is to reduce power consumption, the project might focus on building a predictive model that identifies periods of low activity, allowing the asset tracking device to reduce sensor sampling proactively. Clearly defined goals not only help guide the project but also provide benchmarks for evaluating the effectiveness of the deployed model once it enters production.

Once the business goal 310 is established, various embodiments take a next step involving ML problem framing 320, wherein the goal is translated into a specific machine learning task. This can involve selecting the appropriate type of ML problem, such as classification, regression, clustering, or recommendation, and defining the target variables or outputs. For example, if the goal is to identify hazardous impacts, the problem can be framed as a binary classification task where the model predicts whether a specific accelerometer spike indicates a drop event. Proper problem framing can be important as it determines the particular data requirements, choice of model, and evaluation metrics.

During this stage, it is also prudent to consider the constraints and assumptions that may affect the model's development. This might include data availability, computational resources, ethical considerations, or regulatory compliance. Properly framing the problem ensures that the model development aligns with the business's needs and that the problem is broken down into manageable steps, ultimately increasing the project's chances of success.

Data processing 330 is a step in many embodiments where raw data is collected, cleaned, and transformed into a format suitable for machine learning. This step can involve gathering data from various sources, removing errors or inconsistencies, handling missing values, and normalizing or scaling features to ensure that the model can learn effectively. Feature engineering is often a part of this stage, where new features are derived from the raw data to capture more relevant information and improve model performance.

The quality and preparation of the utilized data can significantly impact the model's accuracy and reliability. Inadequate or poorly processed data can lead to biased or inaccurate predictions, no matter how advanced the model is. Hence, data processing 330 can require or at least benefit from careful planning and iterative refinement. Once the data is processed, it is typically split into training, validation, and test sets to develop and evaluate the model, ensuring that it generalizes well to new, unseen data.

Model development 340 is a phase in a number of embodiments where machine learning algorithms are selected, trained, and refined to create a model that addresses the framed problem. This stage can involve choosing the appropriate algorithm (e.g., decision trees, neural networks, support vector machines), setting up the model's architecture, and defining hyperparameters that will guide the training process. The model is trained on the processed data to identify patterns and relationships that allow it to make predictions or decisions.

During model development 340, the model can be evaluated using the validation dataset to fine-tune its parameters and improve performance. Techniques like cross-validation, regularization, and hyperparameter tuning can be used to prevent overfitting and ensure the model generalizes well. If proper steps are taken, the result is a model that, once it meets predefined performance metrics, is ready for deployment in a real-world environment. However, this process often involves several iterations to optimize the model for the specific business goal, indicated by the arrow back to data processing 330.

In further embodiments, deployment 350 is the stage where the developed model is integrated into the production environment to perform its intended tasks. This phase may involve setting up the necessary infrastructure, such as APIs or cloud-based services, to allow the model(s) to process live data and generate predictions. Deployment 350 can transform the model from a research tool into a functional component of a business process or product, providing real-time insights, automations, or decisions.

The deployment 350 can also include setting up mechanisms for logging, error handling, and user access. Since real-world environments are often dynamic and differ from training conditions, deployment may require continuous adaptation and updates to ensure the model(s) operates efficiently. This step can be important because a model's success is not only determined by its performance metrics but also by its ability to provide actionable results that align with the business goal 310.

In more embodiments, monitoring 360 is the ongoing process of tracking the model's performance and behavior after deployment. It involves collecting data on the model's predictions, accuracy, latency, and error rates to detect issues such as concept drift, where changes in the underlying data patterns can degrade the model's accuracy. By continuously monitoring 360, teams can identify when the model's performance drops and requires retraining or adjustments to align with the evolving data.

Monitoring 360 can also encompass aspects like user feedback, security, and compliance, ensuring that the model remains effective, reliable, and ethical in its application. It may serve as the feedback loop in the lifecycle, where insights gained from monitoring feed back into the earlier stages, such as data processing 330 and model development 340, to refine the model(s) as needed. This iterative process allows the machine learning system to adapt and maintain its alignment with the business goal 310 over time.

Although a specific embodiment for a machine learning lifecycle 300 suitable for carrying out the various steps, processes, methods, and operations described herein is discussed with respect to FIG. 3, any of a variety of systems and/or processes may be utilized in accordance with embodiments of the disclosure. For example, the particular route of development of the model(s) may not follow this cycle completely. As those skilled in the art will recognize, there are a variety of ways to develop AI products that include various iterative steps that aid in development and refinement of different model(s). The elements depicted in FIG. 3 may also be interchangeable with other elements of FIGS. 1-2 and 4-15 as required to realize a particularly desired embodiment.

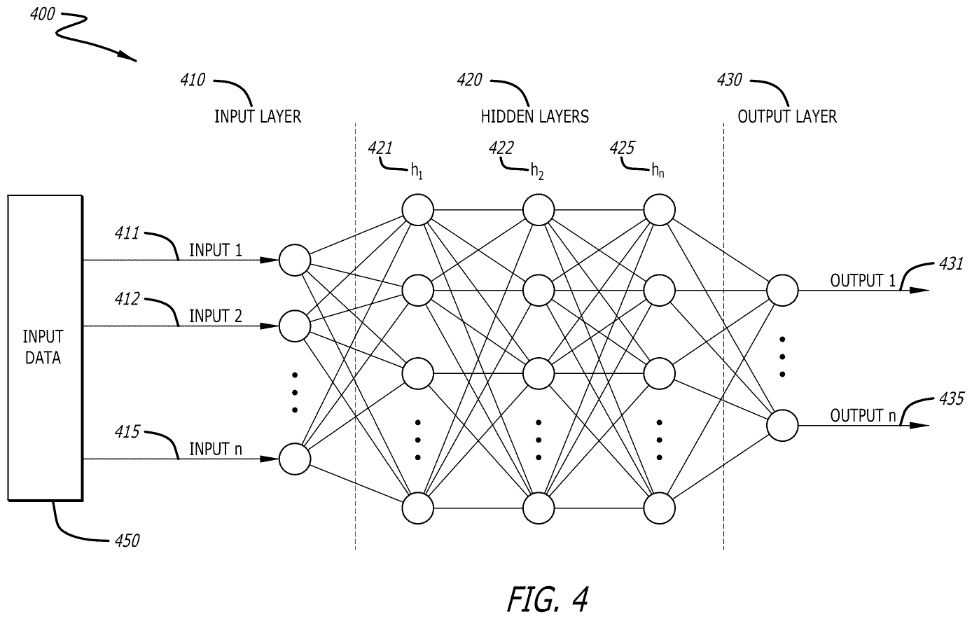

Referring to FIG. 4, a neural network 400 in accordance with various embodiments of the disclosure is shown. The embodiment depicted specifically depicts a feedforward neural network with multiple layers. This type of network consists of an input layer 410, one or more hidden layers 420, and an output layer 430. Each layer contains nodes (or neurons) that are interconnected, representing how data flows through the network. The input layer 410 can receive raw data, which is then processed by the one or more hidden layers 420 through weighted connections and activation functions. The one or more hidden layers 420 can enable the network to learn complex patterns and relationships within the data.

The output layer 430 produces the network's predictions or classifications based on the processed input. The interconnected nature of the nodes allows the neural network 400 to learn from data during training by adjusting the weights of connections to minimize prediction errors. This structure is the foundation of deep learning models, as adding one or more hidden layers 420 can create a deep neural network, capable of tackling highly complex tasks such as image recognition, natural language processing, and pattern detection in large datasets.

A perceptron or a single artificial neuron is the building block of artificial neural networks (ANNs) and can perform forward propagation of information. For a set of inputs to the perceptron, weights (and biases to shift wights) can be assigned. These inputs and weights can be multiplied out correspondingly together to get a sum output. Those skilled in the art will recognize tools such as, but not limited to, PyTorch, Tensorflow, and MXNet as training packages for common neural network tasks. However, it is contemplated that other tools may be developed specifically for the neural network tasks related to the embodiments described herein.

In additional embodiments, the weight matrices of a neural network can be initialized randomly or obtained from a pre-trained model. These weight matrices can be multiplied with the input matrix (or output from a previous layer) and subjected to a nonlinear activation function to yield updated representations, which are often referred to as activations or feature maps. The loss function (also known as an objective function or empirical risk) can often be calculated by comparing the output of the neural network and the known target value data.

Feedforward networks, such as the neural network 400 depicted in the embodiment of FIG. 4, are often configured as neural networks where information moves in one direction, from the input layer through the hidden layers to the output layer, without any cycles or loops. They are primarily used for tasks such as classification, regression, and simple pattern recognition, where each input is processed independently of others. In contrast, backpropagation is not a separate type of network but rather a training algorithm commonly used in both feedforward and other types of networks, like recurrent neural networks (RNNs).

Backpropagation involves adjusting the weights of the network in the reverse direction (from output to input) based on the error between the predicted output and the actual target during training. While feedforward describes the structure and data flow within the network, backpropagation is a technique used to optimize the model. Feedforward networks are ideal for straightforward tasks where input-output relationships are not sequential or time-dependent. However, for problems involving learning complex patterns over time, such as speech recognition or time-series analysis, networks that leverage backpropagation for training, like RNNs or deep feedforward networks with many hidden layers, become necessary to capture these intricate dependencies.

Typically, in these network arrangements, the weights are iteratively updated via various methods including, but not limited to, stochastic gradient descent algorithms in order to help minimize the loss function until the desired accuracy is achieved. Most modern deep learning frameworks can facilitate this by using reverse-mode automatic differentiation to obtain the partial derivatives of the loss function with respect to each network parameter through recursive application of the chain rule. Colloquially, this is also known as back-propagation. Common gradient descent algorithms can include, but are not limited to, Stochastic Gradient Descent (SGD), Adam, Adagrad etc. The learning rate is an important parameter in gradient descent. Except for SGD, all other methods use adaptive learning parameter tuning. Depending on the objective such as classification or regression, different loss functions such as Binary Cross Entropy (BCE), Negative Log Likelihood Loss (NLLL) or Mean Squared Error (MSE) can be used.

Neural network architecture is commonly used for a wide range of tasks in fields such as computer vision, natural language processing, financial forecasting, and materials science. For instance, it can be employed to recognize patterns in images, such as identifying objects or faces, or to classify text into categories, like spam detection in emails. It is also useful in regression problems, such as predicting stock prices or energy consumption, where input features can be processed to output continuous values. However, this is a general example of an artificial intelligence (AI) model, illustrating how a feedforward neural network works. Depending on the problem, other methods and models may be more appropriate. For example, convolutional neural networks (CNNs) are often used for image processing tasks, while recurrent neural networks (RNNs) are suitable for sequential data like time series data or text. Additionally, simpler models like linear regression, decision trees, or support vector machines (SVMs) may be sufficient if the problem is less complex, or the dataset is relatively small. The embodiment depicted in FIG. 4 is presented as an exemplary ML solution that may be deployed within one or more methods or systems described herein.

In many embodiments, the input layer 410 is the first layer in a neural network 400 and serves as the initial point where raw data is introduced into the model. Each node (or neuron) in this layer represents an individual feature or variable from the dataset, allowing the network to receive and process various types of data, such as pixel values in an image, numerical features in a spreadsheet, or words in a text document. For instance, in image recognition tasks, the input layer can consist of nodes that correspond to the pixel values of the image, providing the network with the visual information needed to identify objects or patterns. The number of nodes in the input layer directly depends on the number of features present in the dataset. If there are one-hundred features in the data, the input layer will typically have one-hundred nodes, each conveying one piece of the information to the subsequent layers. In more embodiments, the inputs of the neural network 400 are generally scaled i.e., normalized to have a zero mean and/or unit standard deviation. Scaling can also be applied to the input of hidden layers (using batch or layer normalization) to improve the stability of neural network 400.

Unlike the one or more hidden layers 420 and output layer 430, the input layer 410 typically does not perform any computations or transformations on the data. Its primary function is often to pass the input data to the next layer in the network, the first hidden layer 421. However, it is often desired that the data fed into this layer is preprocessed appropriately, such as being normalized or standardized, to ensure that the neural network can learn efficiently. Proper preprocessing, like scaling numerical values or encoding categorical variables, can help the network process data uniformly, facilitating more stable and faster convergence during training.

The input layer's design depends on the nature of the problem. For example, in natural language processing, the input layer may represent words encoded as numerical vectors, while in time-series analysis, each node might represent a data point in a sequence. While the input layer 410 itself does not modify the data, it sets the stage for the neural network to extract complex patterns and relationships through the deeper layers. This flexibility in handling various types of input make the neural network 400 a powerful tool for a diverse set of applications.

With respect to the embodiments described herein, the input layer may be configured with a plurality of inputs providing input data 450, sensor attributes/parameters or other data sources. For example, a model can be configured with a first input 411 configured as an accelerometer data point, a second input 412 is configured as a gyroscope data point, while additional inputs can be added related to the number of sensors available in the system. The nth input 415 can be configured in certain embodiments to include a battery status metric such that a determination to conserve power may be possible. However, as those skilled in the art will recognize, additional setups can be configured such that the inputs can be configured to also include different parameters of the environment, the number of previous motion events, the overall confidence scores of previous analyses, among other input types, etc.

In a number of embodiments, the neural network 400 comprises one or more hidden layers 420. The embodiment depicted in FIG. 4 comprises a first hidden layer 421, a second hidden layer 422, and an nth hidden layer 425, which are denoted as h₁, h₂, and hₙ respectively. In many embodiments, the one or more hidden layers 420 are where the core of the model's learning and pattern recognition occurs. In each hidden layer, individual neurons receive inputs from the previous layer, apply a set of weights, add a bias, and pass the result through an activation function (e.g., ReLU, leaky ReLU, sigmoid, hyperbolic tangent (tanh), Swish, etc.). This process can introduce non-linearity, allowing the network to capture complex patterns in the data that simple linear models cannot. The intricate web of connections among neurons across layers helps the network transform and process input features into representations that become progressively more abstract and useful for making predictions.

The first hidden layer 421 h1 receives direct input from the input layer, transforming the raw data into an initial set of features. For example, in an image recognition task, this layer might begin identifying basic patterns, such as edges or simple textures. The output of the first hidden layer 421 is then passed to a second hidden layer 422 h2, which builds upon the features identified by the first hidden layer 421. This deeper layer might start recognizing more complex patterns, such as shapes or specific object components, by combining the lower-level features identified earlier. This can continue on until a last, nth hidden layer 425 hₙ continues this abstraction process, allowing the network to recognize even higher-level, more detailed features, such as identifying an entire object within an image or understanding intricate relationships in the input data.

Each hidden layer adds a level of complexity and abstraction to the network's learning capabilities. The multi-layer structure can enable the network to move from recognizing simple patterns in the input layer 410 to highly complex, abstract concepts in the deeper layers. The number of hidden layers and neurons within them can vary depending on the problem's complexity. More hidden layers generally allow the network to model more intricate functions, making deep neural networks especially effective for tasks like image recognition, natural language processing, and complex predictive modeling. However, adding more layers also increases the computational demand and the risk of overfitting, highlighting the need to carefully design and tune these hidden layers for optimal performance.

In various embodiments, the output layer 430 is often the final layer in a neural network and is responsible for producing the network's predictions or classifications based on the information processed through the one or more hidden layers 420. Each neuron in the output layer 430 can represent a specific outcome or category that the model can predict. In the embodiment depicted in FIG. 4, the outputs are labeled as “output 1” to “output n,” indicating that the network can be designed to have a varying number of outputs depending on the nature of the problem being solved for. For example, in a binary classification task (e.g., transmitting a location update vs. maintaining a sleep state), there would typically be a single output neuron that provides a probability score for one of the two classes/outcomes. In contrast, for multi-class classification (e.g., categorizing a motion type between smooth transport, repetitive jostling, or stationary), the output layer would contain multiple neurons, each corresponding to a different class.

The number of neurons in the output layer 430 can also be designed specifically for other types of tasks, such as regression, where the model can predict continuous values. In such cases, the output layer 430 might contain a single neuron representing a numerical prediction, such as the price of a house or the temperature forecast, etc. Alternatively, in complex applications like multi-label classification (where each input can belong to multiple classes simultaneously), the output layer 430 could have multiple neurons, each representing a different class, with each neuron outputting a probability of the input belonging to that specific class.

The activation function used in the output layer can vary based on the desired output. For binary classification, a sigmoid function is commonly used to produce a probability between 0 and 1. For multi-class classifications, a SoftMax function can be applied to output a set of probabilities that sum to 1, indicating the most likely class. For regression problems, a linear activation function is often used to output a continuous range of values. The flexibility in designing the output layer allows the neural network 400 to be applied to a wide variety of tasks, from simple binary decisions to complex multi-output predictions, making them a versatile tool in artificial intelligence and machine learning.

Although a specific embodiment for an exemplary neural network suitable for carrying out the various steps, processes, methods, and operations described herein is discussed with respect to FIG. 4, any of a variety of systems and/or processes may be utilized in accordance with embodiments of the disclosure. For example, real-world neural networks are often far more complex, featuring many more layers, nodes, and connections than the simplified structure shown in the embodiment depicted in FIG. 4, which is an illustrative example meant to make it easier to explain the basic concepts of neural networks and how they process information. The specific features and functions described herein are not intended to be limiting to this specific embodiment. Additionally, the elements depicted in FIG. 4 may also be interchangeable with other elements of FIGS. 1-3 and 5-15 as required to realize a particularly desired embodiment.

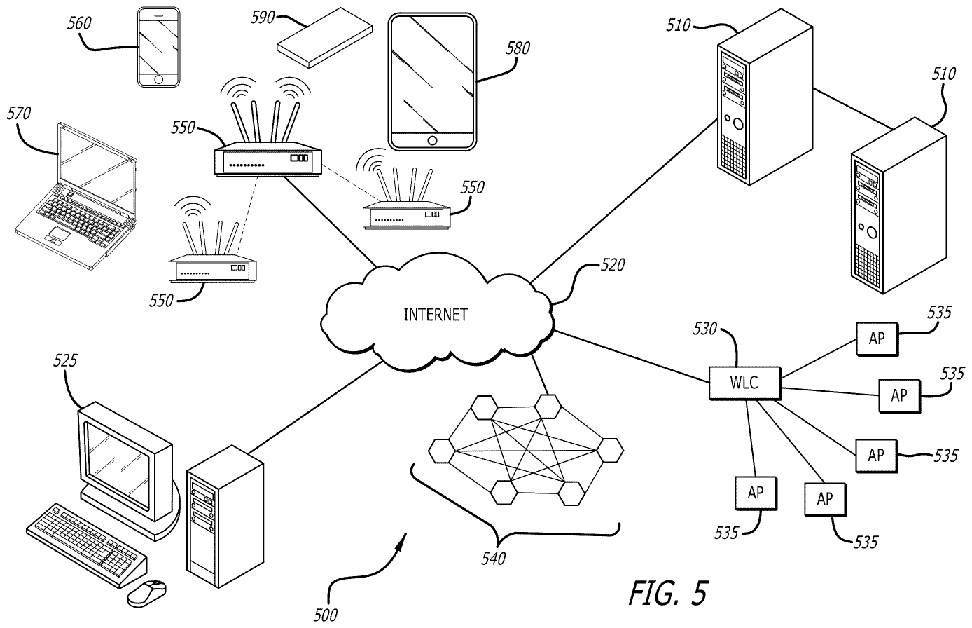

Referring to FIG. 5, a schematic conceptual illustration of a network deployment environment comprising various tracking devices, network infrastructure, and cloud services in accordance with an embodiment of the disclosure is shown. In many embodiments, the network deployment environment 500 provides a communication infrastructure that facilitates the exchange of data between asset tracking devices and backend monitoring systems. This environment can encompass a wide array of network types, ranging from local area networks (LANs) within a single building to wide area networks (WANs) covering expansive campuses or distributed facilities. The network deployment environment 500 serves as the backbone for transmitting sensor data, configuration profiles, and alert notifications, ensuring that asset visibility is maintained across diverse physical locations. Furthermore, the network deployment environment 500 may be configured to support various communication protocols, including Wi-Fi, Bluetooth Low Energy (BLE), and Ultra-Wideband (UWB), allowing for the seamless integration of heterogeneous devices into a unified tracking solution.

In various embodiments, the one or more servers 510 represent centralized computing resources that can host heavy-duty processing tasks, such as long-term data storage, historical trend analysis, and machine learning model training. These one or more servers 510 can be physically located within a private data center or hosted virtually within a public cloud infrastructure accessible via the Internet 520. The Internet 520 acts as a global conduit, connecting local network segments to these centralized resources and enabling remote access for administrators and users located off-site. Additionally, the one or more servers 510 may execute portions of an asset monitoring logic, particularly those requiring significant computational power for tasks like aggregating data from thousands of tags or performing meta-learning updates to refine detection models across an entire enterprise.

In a number of embodiments, the wireless LAN controller 530 functions as a management entity for a plurality of access points 535, coordinating their operation and handling data traffic between the wireless edge and the wired core. The wireless LAN controller 530 can be responsible for pushing configuration updates to the plurality of access points 535, managing radio frequency (RF) parameters to minimize interference, and aggregating location data received from tracking devices. Each of the plurality of access points 535 serves as a point of attachment for wireless devices, broadcasting beacon signals and listening for uplink transmissions from asset tags within their coverage areas. These plurality of access points 535 may be equipped with specialized radios, such as BLE or UWB transceivers, enabling them to act as anchors for precise ranging and location triangulation in addition to their standard data transport duties.

In some embodiments, the distributed network structure 540 illustrates a mesh or peer-to-peer topology where network nodes communicate directly with one another to extend coverage without relying on a centralized controller for every hop. This configuration is particularly advantageous in challenging environments like warehouses or industrial yards where running cabling to every access point is impractical or cost prohibitive. The distributed network structure 540 allows data to hop from one node to another until it reaches a gateway, ensuring that asset location data can still be collected even from deep within a facility. Furthermore, this topology supports resilience, as the failure of a single node does not necessarily isolate a segment of the network, allowing the asset monitoring system to maintain continuity of operations.

In further embodiments, the one or more gateways 550 act as intermediaries that bridge different network protocols or physical media, such as converting wireless sensor data into Ethernet packets for transmission over the wired network. These one or more gateways 550 can be deployed in remote or satellite locations, providing a localized aggregation point for asset data before it is forwarded to the central servers. Additionally, the one or more gateways 550 may possess edge computing capabilities, allowing them to perform preliminary data filtering or immediate alert generation for time-sensitive events. By processing data closer to the source, the one or more gateways 550 help reduce latency and bandwidth consumption, ensuring that only relevant or anomalous events are transmitted across the wider network.

In additional embodiments, a variety of end-user computing devices, such as the desktop computer 525, the laptop computer 570, the mobile phone 560, and the tablet device 580, provide interfaces for users to interact with the asset tracking system. The desktop computer 525 and the laptop computer 570 are often utilized by system administrators or facility managers to view comprehensive dashboards, configure system parameters, and generate detailed reports on asset utilization. Meanwhile, the mobile phone 560 and the tablet device 580 enable mobile staff, such as nurses or warehouse pickers, to receive real-time location updates and “find” directions while moving through the facility. These devices allow for immediate responsiveness, ensuring that personnel can quickly locate critical equipment or respond to alerts generated by the asset monitoring logic regarding unauthorized movement or impacts.

In yet more embodiments, the asset tracking tag 590 represents the edge device physically attached to the equipment being monitored, capable of sensing motion, environmental conditions, and location signals. The asset tracking tag 590 is designed to operate on battery power for extended periods, utilizing intelligent logic to toggle between low-power sleep states and active transmission modes based on detected activity. This device communicates with the surrounding network infrastructure, sending beacon signals or telemetry data to the access points or gateways. Furthermore, the asset tracking tag 590 may host its own instance of the asset monitoring logic, allowing it to perform local decision-making, such as classifying motion types or determining when to switch from a coarse BLE tracking mode to a precise UWB ranging mode.

In certain embodiments, the execution of the asset monitoring logic can be distributed across multiple components within the network deployment environment 500 to optimize performance and resource utilization. For instance, the asset tracking tag 590 can perform the initial motion classification locally to filter out insignificant vibrations, sending only confirmed transport events to the one or more gateways 550. The one or more gateways 550 can then aggregate these events and correlate them with local zone data before forwarding the information to the one or more servers 510. Finally, the one or more servers 510 can integrate this data with historical records to update predictive maintenance models, demonstrating a tiered processing approach that conserves bandwidth and processing power at the edge while leveraging the storage capacity of the cloud.

In various embodiments, a user utilizing the mobile phone 560 can initiate a search for a specific piece of equipment tagged with the asset tracking tag 590. The request is transmitted through the Internet 520 to the one or more servers 510, which identify the last known zone of the asset based on data received from the wireless LAN controller 530. The system then triggers the asset tracking tag 590 to switch to a high precision advertising mode, allowing the plurality of access points 535 to triangulate its exact position. This precise location data is sent back to the mobile phone 560, providing the user with turn-by-turn navigation to the asset, thereby streamlining operational workflows in large, complex facilities.

In many embodiments, the desktop computer 525 can be used to push a new configuration profile to the asset tracking tag 590 via the network infrastructure. An administrator may define a new sensitivity threshold for a specific group of assets entering a high-security storage area. This configuration update propagates from the desktop computer 525 through the Internet 520 and the wireless LAN controller 530 to the plurality of access points 535 covering that zone. When the asset tracking tag 590 comes within range, it receives the new parameters and updates its internal monitoring logic, ensuring that its behavior aligns with the current security policies without requiring physical interaction with the device.

Although a specific embodiment for a schematic conceptual illustration of a network deployment environment comprising various tracking devices, network infrastructure, and cloud services suitable for carrying out the various steps, processes, methods, and operations described herein is discussed with respect to FIG. 5, any of a variety of systems and/or processes may be utilized in accordance with embodiments of the disclosure. For example, the network deployment environment 500 can utilize cellular networks (e.g., LTE, 5G) as the primary backhaul for the one or more gateways 550 instead of wired connections. The elements depicted in FIG. 5 may also be interchangeable with other elements of FIGS. 1-4 and 6-15 as required to realize a particularly desired embodiment.

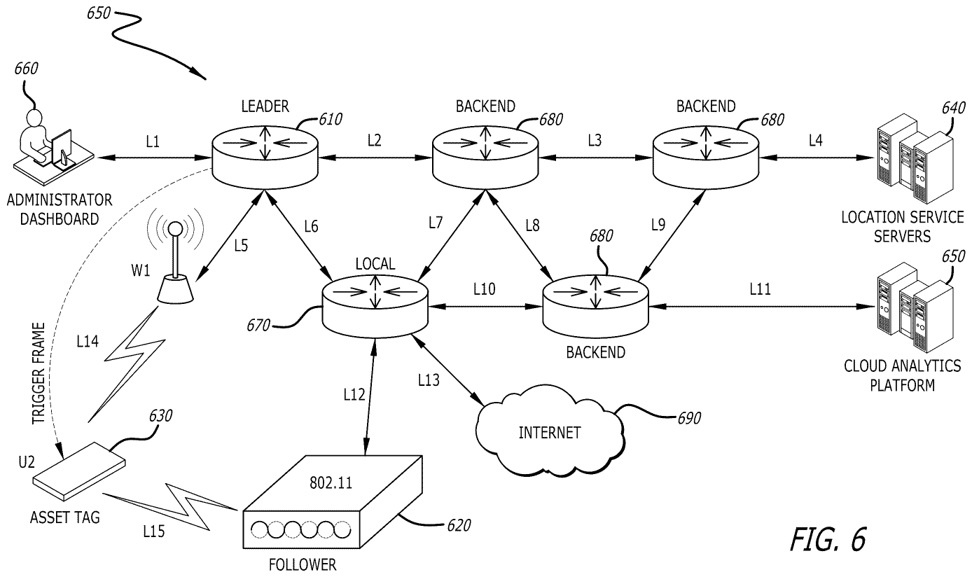

Referring to FIG. 6, a conceptual illustration of a multi-access point topology configured for coordinated triggered uplink access in accordance with various embodiments of the disclosure is shown. In many embodiments, the multi-access point coordination system 600 defines a specialized network architecture designed to optimize the energy efficiency of wireless communication between infrastructure nodes and edge devices. This topology addresses the specific power constraints of battery-operated sensors by decoupling the responsibilities of signal transmission and signal reception across different network entities. By assigning distinct roles to the available hardware, the multi-access point coordination system 600 can mitigate the high energy costs typically associated with continuous listening and high-power broadcasting. Furthermore, this coordinated approach allows for the creation of synchronized communication windows, ensuring that devices wake up only when necessary and communicate with the most appropriate network node for their current location and channel conditions.

In various embodiments, the leader access point 610 functions as the primary synchronization source and control signaling entity within the coordination group. The leader access point 610 is typically configured with a power budget and radio capabilities that allow it to transmit high-energy control signals, such as the trigger frame W1, over a wide coverage area. This device acts as the “shouting” node that penetrates deep sleep states of surrounding devices, delivering critical timing information and slot allocations without requiring the receiving devices to expend significant energy on negotiation. Additionally, the leader access point 610 may be responsible for managing the scheduling of the air interface, ensuring that multiple devices do not collide during their respective uplink transmission windows.

In a number of embodiments, the follower access point 620 serves as the dedicated receiver node, optimized for listening to the low-power signals transmitted by the edge devices. Unlike the leader access point 610, the follower access point 620 may prioritize receiver sensitivity and proximity to the assets over transmission power. The follower access point 620 captures the uplink data streams that are triggered by the leader, effectively acting as the “ears” of the system while the leader acts as the “voice.” By offloading the reception duty to the follower access point 620, the system ensures that an asset can communicate with a nearby node using minimal transmission power, even if that node was not the one that issued the wake-up command.

In some embodiments, the asset tracking tag 630 represents the mobile or stationary end-device that requires monitoring and location services. The asset tracking tag 630 is engineered to remain in a low-power, dormant state for the majority of its operational life to maximize battery longevity. This device is configured to listen for specific trigger signatures, such as those provided by the leader access point 610, and only activate its primary radio and processing subsystems upon successful detection of such a trigger. Once active, the asset tracking tag 630 executes its assigned task, such as measuring sensor values or generating a location beacon, and transmits the resulting data via the uplink connection L15 before immediately returning to its sleep state.

In further embodiments, the location service servers 640 provide the computational logic required to translate raw radio telemetry into meaningful geospatial coordinates. The location service servers 640 receive timestamped signal data from the various access points and apply algorithms such as time-difference-of-arrival (TDoA) or angle-of-arrival (AoA) to pinpoint the position of the asset tracking tag 630. These servers act as the central repository for location history, maintaining a database of where assets have been and where they are currently predicted to be. Additionally, the location service servers 640 may handle the complex geometry calculations that are too computationally intensive for the edge devices to perform locally.

In additional embodiments, the cloud analytics platform 650 offers a higher-level processing environment where data from the location service servers 640 is aggregated with other enterprise data streams. The cloud analytics platform 650 utilizes machine learning models to identify utilization trends, detect anomalies in asset movement, and predict maintenance needs based on historical performance. This platform allows for the integration of asset data with business logic, transforming raw location points into actionable operational insights. Furthermore, the cloud analytics platform 650 provides the scalability needed to handle data from thousands of deployed tags across multiple geographic sites.

In yet more embodiments, the administrator dashboard 660 acts as the human-machine interface for the entire asset tracking solution. The administrator dashboard 660 visualizes the data processed by the cloud analytics platform 650, presenting users with interactive maps, alert logs, and system health indicators. Through this interface, facility managers can define geofences, set alert thresholds, and view the real-time status of critical equipment. The administrator dashboard 660 also provides the configuration controls necessary to adjust the behavior of the leader and follower access points, allowing for the fine-tuning of the system's performance.

In specific embodiments, the local aggregation device 670 functions as a network switch or router that funnels traffic from the wireless edge toward the network core. The local aggregation device 670 physically connects the leader access point 610 and the follower access point 620 to the wired backhaul, ensuring that the high-speed data streams are managed efficiently within the local facility. This device handles the layer-2 and layer-3 switching tasks, isolating local traffic from the wider wide area network where appropriate. Additionally, the local aggregation device 670 may provide Power over Ethernet (POE) to the attached access points, simplifying the physical deployment of the infrastructure.

In still further embodiments, the backend network devices 680 comprise the core routing and switching infrastructure that bridges the local network to external services and the internet. The backend network devices 680 ensure the reliable transport of data packets over long distances, employing protocols that prioritize the integrity and security of the asset data. These devices manage the connections represented by links L2, L3, L4, L8, L9, L10, and L11, creating a resilient pathway for information flow. By handling the heavy lifting of data transport, the backend network devices 680 allow the edge devices to focus on their specific sensing and coordination tasks.

In various embodiments, the Internet 690 serves as the public or private wide area network that connects the on-premises infrastructure to the remote cloud services. The Internet 690 enables the global reach of the system, allowing centralized servers to manage deployments scattered across different cities or countries. It acts as the final transport medium for data moving between the backend network devices 680 and the cloud-based processing platforms. Additionally, the Internet 690 facilitates the delivery of over-the-air firmware updates and security patches to the deployed hardware.

In one example of the system's operation, the leader access point 610 initiates a synchronization event by broadcasting a trigger frame W1 across a designated high-sensitivity zone. This transmission is performed at a high decibel level to ensure it reaches all devices in the area, including those buried deep within storage containers or obstructed by equipment. The asset tracking tag 630, which has been in a deep sleep mode to conserve its battery, detects this specific preamble or wake-up signature. Upon validation of the trigger frame W1, the asset tracking tag 630 powers up its primary radio circuit, bypassing the need to continuously scan for available networks, thereby significantly reducing its idle power consumption.

In a second example involving data transmission, once the asset tracking tag 630 is awake, it captures motion data from its internal sensors and prepares an uplink payload. Instead of attempting to communicate back to the leader access point 610, the asset tracking tag 630 transmits the uplink data L15 at a low power setting optimized for short-range communication. The follower access point 620, positioned in close proximity to the tag, successfully decodes this low-energy transmission. This “hear-but-don't-shout” configuration allows the asset tracking tag 630 to close the link budget with the follower access point 620 using a fraction of the energy that would be required to reach the leader, while the leader continues to handle the energy-intensive task of network organization.

In a third example regarding data processing and visualization, the follower access point 620 forwards the received sensor payload through the local aggregation device 670 and the backend network devices 680 to the location service servers 640. The servers calculate the tag's position and pass the result to the cloud analytics platform 650, which compares the movement against a historical model. If the cloud analytics platform 650 determines that the asset tracking tag 630 has entered a restricted area, it generates an immediate alert notification. This alert is pushed via the Internet 690 to the administrator dashboard 660, where a security officer can see the asset's icon flashing red on the facility map and dispatch personnel to investigate.

Although a specific embodiment for a conceptual illustration of a multi-access point topology configured for coordinated triggered uplink access suitable for carrying out the various steps, processes, methods, and operations described herein is discussed with respect to FIG. 6, any of a variety of systems and/or processes may be utilized in accordance with embodiments of the disclosure. For example, the roles of the leader access point 610 and the follower access point 620 may be dynamic, rotating among different hardware nodes based on their current battery levels or network load to prevent any single device from becoming a point of failure. The elements depicted in FIG. 6 may also be interchangeable with other elements of FIGS. 1-5 and 7-15 as required to realize a particularly desired embodiment.

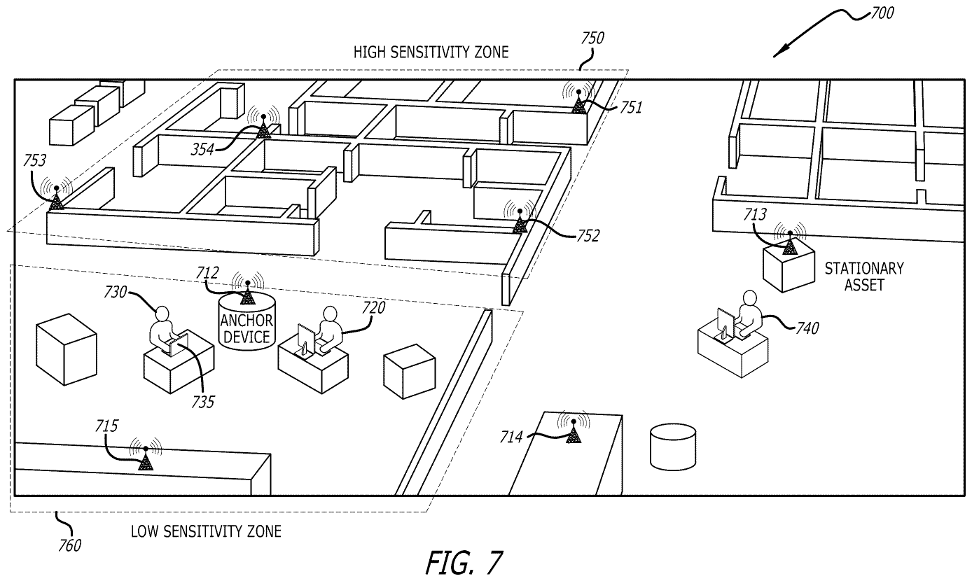

Referring to FIG. 7, a conceptual illustration of a physical environment utilizing context-aware zones to govern asset tracking sensitivity in accordance with various embodiments of the disclosure is shown. In many embodiments, the physical environment 700 represents a real-world facility, such as a warehouse, hospital, or manufacturing plant, where assets are stored, utilized, and transported. The physical environment 700 is spatially divided into distinct logical areas that correspond to different operational requirements and security levels. As depicted, these areas can include a high sensitivity zone 750 and a low sensitivity zone 760, which are defined by the coverage areas of specific network infrastructure devices. By segmenting the physical environment 700 into these zones, the asset tracking system can enforce different behavioral rules for tracking devices depending on their current physical location. This zoning strategy allows for a granular approach to power management and security, ensuring that the asset tags operate with the appropriate level of vigilance required for their immediate surroundings.

In various embodiments, the high sensitivity zone 750 is delineated by a dense arrangement of network nodes, including a first shelf access point 751, a second shelf access point 752, a third shelf access point 753, and a fourth shelf access point 354. These devices may be mounted directly onto storage infrastructure, such as shelving units or secure cabinets, to create a tightly controlled monitoring area. The high sensitivity zone 750 typically corresponds to a storage area where assets are expected to remain stationary for extended periods, such as an inventory room or a restricted equipment locker. Because authorized movement in this area is minimal, the monitoring logic can be configured to detect even the slightest vibrations or displacements. Consequently, the network nodes within this zone, such as the first shelf access point 751, may continually broadcast zone-specific identifiers that instruct nearby tags to lower their motion acceleration thresholds to a minimum level.

In a number of embodiments, the low sensitivity zone 760 covers a broader, more open space within the physical environment 700, monitored by devices such as an anchor device 712, a stationary asset 713 (which may act as a reference point), a pillar access point 714, and a wall access point 715. This zone may represent a high-traffic area, such as a hallway, a loading dock, or an active workspace, where legitimate asset movement is frequent and expected. In the low sensitivity zone 760, the tracking system prioritizes battery conservation and the reduction of false positives over hyper-sensitive motion detection. The anchor device 712 and surrounding access points may transmit configuration parameters that instruct tags to ignore minor vibrations associated with ambient environmental noise or routine transport. This setup ensures that assets moving through the low sensitivity zone 760 do not generate a flood of unnecessary alerts or wake-up events, thereby preserving network bandwidth and energy resources.

In some embodiments, the physical environment 700 contains various items and personnel that interact with the tracking system, including a first user 720, a second user 730, a floor asset 735, and a third user 740. The presence of the first user 720 near the anchor device 712 may indicate an active workflow where assets are being checked out or serviced. The floor asset 735, located within the low sensitivity zone 760, might be a mobile piece of equipment like a wheelchair or a pallet jack that is currently in use. The interaction between the users and the assets can be logged by the system to provide context for motion events. For instance, if the third user 740 is detected in proximity to the stationary asset 713, a subsequent motion event might be classified as an authorized retrieval rather than a theft, illustrating how the system integrates location data with user presence to refine its analysis.

In one example of operation within the high sensitivity zone 750, a tracking tag attached to a high-value item located near the second shelf access point 752 enters a heightened security state. Upon receiving the zone identifier from the second shelf access point 752, the tag updates its internal configuration to utilize a high-precision motion profile. In this state, the tag might interpret even a single millimeter of displacement or a slight vibration as a potential security breach. If movement is detected, the tag can immediately wake up its high-power radio to transmit a distress signal to the third shelf access point 753, ensuring that security personnel are notified instantly of the potential unauthorized handling. This rigorous monitoring is maintained as long as the tag remains within the boundaries defined by the shelf access points.

In a second example occurring within the low sensitivity zone 760, the floor asset 735 is being transported across the room by the second user 730. As the floor asset 735 moves past the wall access point 715, the attached tag recognizes that it is in a transit corridor. Consequently, the tag applies a “transport” configuration profile that filters out the continuous vibration noise caused by the wheels rolling over the floor. Instead of waking up for every bump, the tag might only transmit location updates at fixed intervals or upon reaching a specific destination, such as the area near the pillar access point 714. This behavior prevents the battery from draining during routine operations while still maintaining visibility of the asset's general location.

In a third example regarding the transition between zones, consider an asset being moved from the low sensitivity zone 760 into the high sensitivity zone 750. As the asset crosses the threshold, it may lose connection with the anchor device 712 and establish a new link with the fourth shelf access point 354. The logic on the tag detects this handover and automatically switches its monitoring profile from “transit” to “secure storage.” This dynamic handoff ensures that the asset is protected the moment it is placed on the shelf, without requiring manual reconfiguration by the user. Conversely, if an asset is removed from the shelf, the system detects the transition away from the first shelf access point 751 and can log the exact time the item left the secure zone.

Although a specific embodiment for a conceptual illustration of a physical environment utilizing context-aware zones to govern asset tracking sensitivity suitable for carrying out the various steps, processes, methods, and operations described herein is discussed with respect to FIG. 7, any of a variety of systems and/or processes may be utilized in accordance with embodiments of the disclosure. For example, the zones could be defined dynamically based on time of day, wherein the physical environment 700 in its entirety becomes a high sensitivity zone after business hours. The elements depicted in FIG. 7 may also be interchangeable with other elements of FIGS. 1-6 and 8-15 as required to realize a particularly desired embodiment.

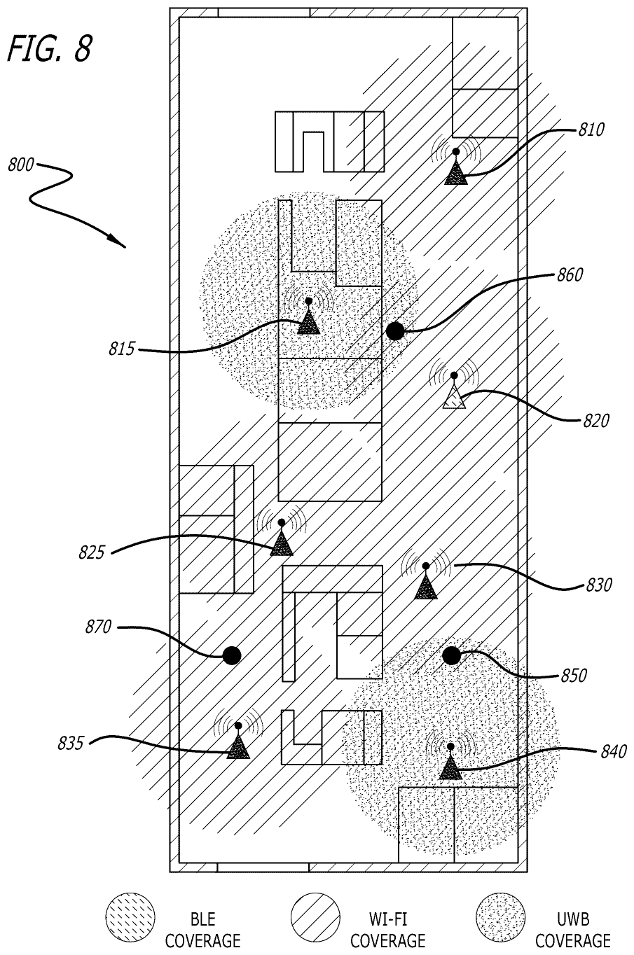

Referring to FIG. 8, a conceptual illustration of a coverage map depicting overlapping sensor coverage zones for hybrid sensor polling in accordance with various embodiments of the disclosure is shown. In many embodiments, the coverage map 800 visualizes a heterogeneous network environment where multiple wireless technologies coexist to provide varying levels of tracking granularity and service coverage. This layered approach allows the asset tracking system to balance the high-power requirements of precision location technologies with the extensive range and low energy consumption of standard communication protocols. By strategically placing different types of network nodes, the physical space is divided into distinct zones of influence, such as wide-area zones for general presence detection and concentrated precision zones for detailed spatial analysis. Consequently, an asset tracking device moving through this environment can intelligently switch between transmission modes, utilizing the most appropriate radio frequency technology based on its immediate location and the specific tracking requirements of the zone it currently occupies.

In various embodiments, the infrastructure supporting the coverage map 800 comprises a distributed array of network hardware, including a first access point 810, a second access point 820, a third access point 825, a fourth access point 830, and a fifth access point 835. These devices are typically configured to provide broad, continuous signal coverage, such as Bluetooth Low Energy (BLE) or Wi-Fi, represented by the hatched patterns filling the majority of the floor plan. They serve as the primary communication backbone, ensuring that assets remain connected and visible to the system even when they are in transit corridors or general storage areas where high-precision localization is not required. Additionally, the environment includes specialized hardware depicted as a first precision anchor 815 and a second precision anchor 840. These anchors are deployed in specific areas of interest to generate high-fidelity coverage zones, indicated by the stippled circular patterns, which utilize technologies like Ultra-Wideband (UWB) to enable centimeter-level ranging and precise coordinate calculation.

In a number of embodiments, the system simultaneously monitors a plurality of tracking devices, represented by a first asset tag 850, a second asset tag 860, and a third asset tag 870, each located within different coverage intersections. The first asset tag 850 is depicted within the immediate range of the second precision anchor 840, effectively placing it inside a high-priority tracking zone where exact location data is readily available. In contrast, the second asset tag 860 and the third asset tag 870 are positioned within the broader coverage areas provided by the surrounding access points. The location of each tag relative to these infrastructure nodes dictates the specific “confidence score” the system assigns to its position, as well as the power profile the tag adopts to maintain communication. This distribution illustrates the capacity of the system to handle diverse tracking scenarios simultaneously, ranging from precise inventory positioning to general presence monitoring.

In one example of operation, the first asset tag 850 detects the presence of the high-precision signal broadcast by the second precision anchor 840. Upon entering this stippled coverage zone, the asset monitoring logic on the first asset tag 850 transitions from a low-power sleep state into a high-performance ranging mode. The tag initiates a two-way time-of-flight measurement exchange with the second precision anchor 840, allowing the backend system to pinpoint the asset's location with a high degree of accuracy. This capability is particularly useful for validating that critical equipment has been returned to a specific charging dock or secure storage bay, ensuring automated compliance with facility protocols.

In a second example, the third asset tag 870 is located in a region covered primarily by the third access point 825 and the fifth access point 835. In this scenario, the tag determines that it is outside the range of any precision anchors and defaults to a standard low-energy profile. The third asset tag 870 relies on measuring the received signal strength indicator (RSSI) from the broadcasts of the third access point 825 and the fifth access point 835 to estimate its approximate location. By utilizing these lower-power signals for rough positioning, the tag significantly conserves its battery life, making this mode ideal for assets stored in bulk where identifying the specific aisle or room is sufficient for operational needs.

In a third example regarding dynamic transitions, the second asset tag 860 may be in motion, traveling from the vicinity of the second access point 820 toward the coverage area of the first precision anchor 815. As the second asset tag 860 approaches the boundary of the high-precision zone, it may begin to detect advertisement packets from the first precision anchor 815. The logic within the tag evaluates the signal quality and, upon crossing a predefined threshold, seamlessly hands off the tracking session from the coarse BLE network to the precision UWB network. This automatic handover ensures that as the asset enters a critical workflow area, such as a surgical suite or a shipping dock, the tracking resolution is automatically upgraded to support the enhanced visibility requirements of that zone.

Although a specific embodiment for a conceptual illustration of a coverage map depicting overlapping sensor coverage zones for hybrid sensor polling suitable for carrying out the various steps, processes, methods, and operations described herein is discussed with respect to FIG. 8, any of a variety of systems and/or processes may be utilized in accordance with embodiments of the disclosure. For example, the network nodes such as the first access point 810 and the first precision anchor 815 could be combined into a single physical hardware unit containing multiple radios, rather than being deployed as separate devices. The elements depicted in FIG. 8 may also be interchangeable with other elements of FIGS. 1-7 and 9-15 as required to realize a particularly desired embodiment.

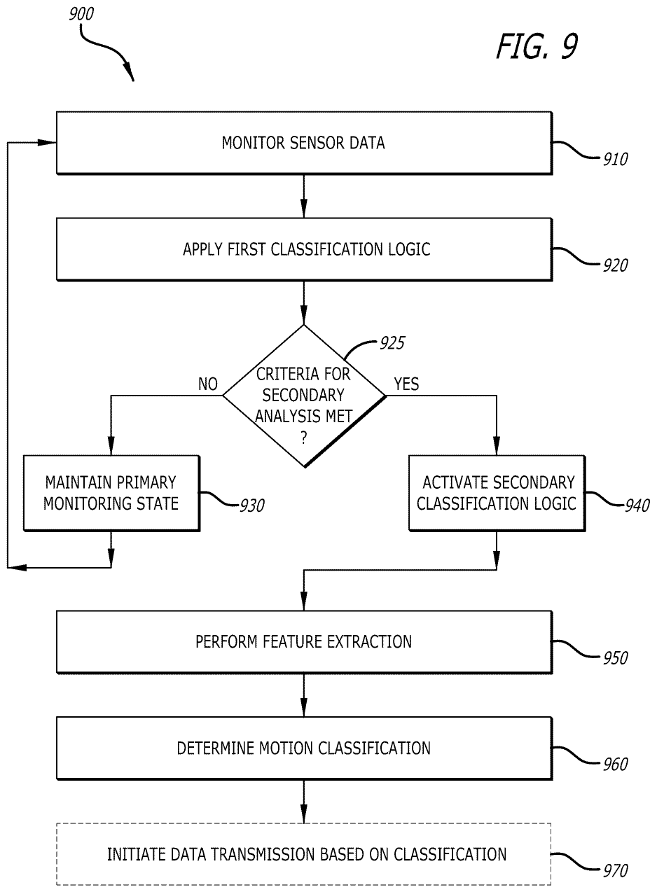

Referring to FIG. 9, a flowchart depicting a process 900 for hierarchical motion classification utilizing primary and secondary classification logic in accordance with various embodiments of the disclosure is shown. In many embodiments, the process 900 can monitor sensor data (block 910). In some embodiments, the monitoring involves continuously sampling an accelerometer or gyroscope at a low frequency to detect basic vibration presence or orientation changes. For example, the process might poll the sensor at 1 Hz to save battery while the device is stationary, only increasing the rate when a threshold is crossed. In other embodiments, the monitoring can be event-driven, where the sensor hardware itself triggers an interrupt upon crossing a pre-configured magnitude threshold. For instance, a “wake-on-shake” feature in the accelerometer hardware could initiate the logic only when significant force is applied, allowing the main processor to remain in a deep sleep state until necessary.

In a number of embodiments, the process 900 can apply first classification logic (block 920). In certain embodiments, this logic utilizes a lightweight decision tree algorithm designed to categorize motion into broad states such as stationary, low motion, or high motion without consuming significant computational resources. For example, a CART algorithm might evaluate the variance of acceleration over a short time window to determine if the device is effectively still or experiencing minor jitter. In various embodiments, the logic compares the raw sensor magnitude against a set of pre-defined static thresholds to quickly filter out noise from meaningful signal. For instance, any signal amplitude below a specific g-force floor might be immediately discarded as environmental background noise without further processing.

In more embodiments, the process 900 can determine if criteria for secondary analysis are met (block 925). If the criteria for secondary analysis are not met, then the process 900 can maintain primary monitoring state (block 930). However, if the criteria for secondary analysis are met, then the process 900 can activate secondary classification logic (block 940). This determination effectively acts as a gatekeeper or filter, ensuring that energy-intensive processing is only engaged when the lightweight logic cannot sufficiently characterize the event. For example, if the first classification logic determines the device is merely vibrating due to HVAC noise, the criteria for secondary analysis would not be met. Conversely, if the variance exceeds a “high motion” threshold indicating potential transport, the system determines that the criteria are satisfied and proceeds to the next stage.

In further embodiments, the process 900 can maintain primary monitoring state (block 930). In some embodiments, this involves returning the processor to a low-power sleep mode while keeping the sensor active for the next scheduled sample. For example, the system might log a “heartbeat” timestamp to confirm operation but otherwise take no action and wait for the next interrupt. In other embodiments, maintaining the state includes resetting any accumulation buffers or timers used for the first classification logic to ensure the next reading is fresh. For instance, the process might clear the last few seconds of vibration data buffer before restarting the monitoring cycle to prevent old data from influencing future wake-up decisions.

In additional embodiments, the process 900 can activate secondary classification logic (block 940). In various embodiments, this step involves powering up a dedicated machine learning hardware accelerator or a digital signal processor (DSP) to handle complex computations that the primary logic could not perform. For example, the main microcontroller might wake up a neural processing unit (NPU) to load a Convolutional Neural Network (CNN) model or a Temporal Convolutional Network (TCN). In certain embodiments, activation includes loading a specific model architecture from memory that is specifically tailored to the detected intensity level found in the previous step. For instance, a “high impact” model might be loaded if the first stage detected a shock, while a “vibration” model is loaded if continuous shaking was detected.

In still more embodiments, the process 900 can perform feature extraction (block 950). In some embodiments, this process transforms time-domain sensor data into frequency-domain representations using Fast Fourier Transforms (FFT) to isolate specific vibration characteristics. For example, the logic might identify dominant frequencies to distinguish between the rhythmic vibration of a motor and the random jolts of a cart on a rough surface. In other embodiments, feature extraction involves calculating statistical metrics such as kurtosis, skewness, or root mean square (RMS) values from the raw data stream. For instance, a high kurtosis value might be extracted to highlight the “spikiness” or impulsiveness of an impact event relative to the background noise level.

In yet further embodiments, the process 900 can determine motion classification (block 960). In many embodiments, the secondary logic inputs the extracted features into a neural network to assign a specific semantic label to the motion event. For example, the model might classify the motion as “forklift transport,” “manual carrying,” “hazardous drop,” or “conveyor belt movement.” In some embodiments, the classification results in a confidence score associated with multiple potential categories rather than a single binary output. For instance, the output might indicate an 85% probability of “smooth transport” and a 15% probability of “elevator movement,” allowing the system to make a decision based on the highest probability.

In yet additional embodiments, the process 900 can initiate data transmission based on classification (block 970). In various embodiments, a transmission is only triggered if the classification meets a priority threshold or security condition, such as a detected impact or theft attempt. For example, a “drop” classification triggers an immediate Ultra-Wideband (UWB) alert to pinpoint location, whereas a “stationary” results in no transmission to save power. In other embodiments, the transmission includes the classification label itself as part of the payload to the backend server to assist in analytics. For instance, the tag might send a Bluetooth Low Energy (BLE) advertisement packet containing a status byte indicating “In Transit” so that the network knows the asset is currently mobile.

Although a specific embodiment for a process 900 for hierarchical motion classification utilizing primary and secondary classification logic suitable for carrying out the various steps, processes, methods, and operations described herein is discussed with respect to FIG. 9, any of a variety of systems and/or processes may be utilized in accordance with embodiments of the disclosure. For example, the first classification logic and secondary classification logic could be combined into a single step if the hardware capabilities allow for low-power neural network processing without a wake-up gate. The elements depicted in FIG. 9 may also be interchangeable with other elements of FIGS. 1-8 and 10-15 as required to realize a particularly desired embodiment.

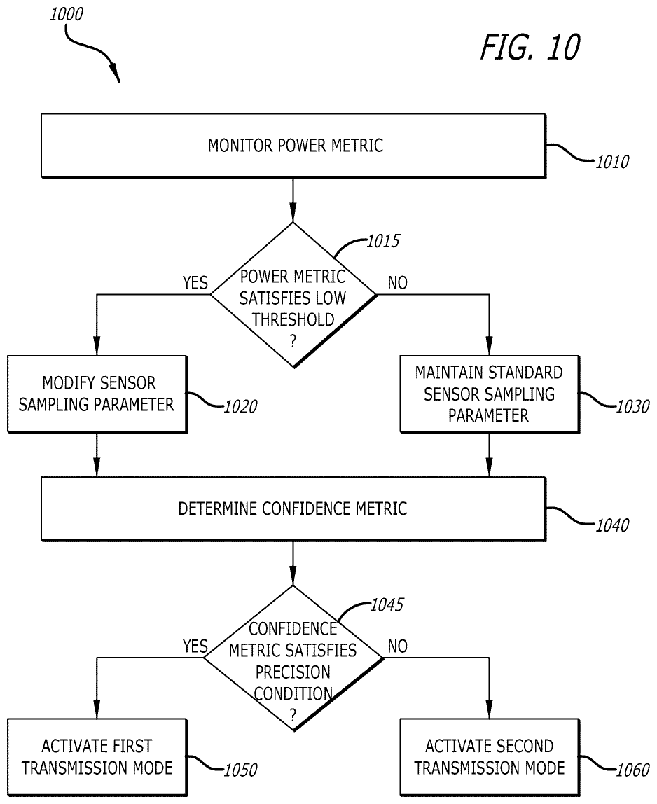

Referring to FIG. 10, a flowchart depicting a process 1000 for dynamic power and sensor management in accordance with various embodiments of the disclosure is shown. In many embodiments, the process 1000 can monitor power metric (block 1010). In some embodiments, this involves the main processor periodically querying a fuel gauge integrated circuit to obtain the current state of charge (SoC) of the battery. For example, the logic might read the remaining battery percentage every few minutes to determine if it has dropped below a critical level. In other embodiments, the power metric includes calculating an estimated remaining runtime based on current consumption rates and historical usage patterns. For instance, the system might project that the current heavy usage of the UWB radio will deplete the battery in less than a week, prompting a preemptive shift to a power-saving mode.

In a number of embodiments, the process 1000 can determine if the power metric satisfies a low threshold (block 1015). If the power metric satisfies the low threshold (e.g., battery is low), then the process 1000 can modify sensor sampling parameter (block 1020). However, if the power metric does not satisfy the low threshold (e.g., battery is sufficient), then the process 1000 can maintain standard sensor sampling parameter (block 1030). This decision point allows the device to gracefully degrade its performance to extend its operational life. For example, if the battery drops below 20%, the system might decide that extending the device's lifespan is more critical than capturing every minor vibration event.

In further embodiments, the process 1000 can modify sensor sampling parameter (block 1020). In certain embodiments, this involves reducing the frequency at which the accelerometer is polled, such as dropping from 10 Hz to 1 Hz. For example, instead of checking for motion ten times a second, the device only checks once, significantly reducing the duty cycle of the sensor and the processor. In various embodiments, the modification includes disabling secondary sensor axes or reducing the bit-depth of the measurements to save processing power. For instance, the system might switch from 3-axis monitoring to single-axis monitoring if the primary concern is simply detecting presence rather than orientation.

In specific embodiments, particularly when the device is operating in a power conservation state, the asset monitoring logic is further configured to apply a linear interpolation algorithm to the motion data collected by the sensors. This mathematical processing allows the logic to effectively reconstruct one or more gaps in the motion data resulting from the reduced sampling frequency utilized to save battery life. By estimating the intermediate values between the sparse data points, the system can generate a continuous motion profile that remains useful for analysis without incurring the energy penalty of high-frequency polling. Consequently, the device maintains a coherent record of activity that can still be used to verify the status of the asset despite the lower fidelity of the raw sensor input.

In additional embodiments, the process 1000 can maintain standard sensor sampling parameter (block 1030). In some embodiments, this entails continuing to operate the sensors at their default, high-performance settings to ensure maximum data fidelity. For example, a tag on a critical asset might continue to sample at 50 Hz to ensure that any shock or drop event is captured with high temporal resolution. In other embodiments, maintaining the standard parameter includes keeping all auxiliary sensors, such as gyroscopes or magnetometers, active to provide a complete context of the asset's movement.

In still more embodiments, the process 1000 can determine confidence metric (block 1040). In many embodiments, the logic calculates a score representing the certainty that the current sensor data reflects a significant event requiring high-precision tracking. For example, the system might analyze the consistency of accelerometer spikes to determine if they represent a sustained transport event (high confidence) or random noise (low confidence). In some embodiments, the confidence metric integrates historical data, such as whether the asset is currently in a high-traffic zone where movement is expected. For instance, a motion event in a hallway during working hours might yield a lower urgency confidence than the same motion in a secure vault at night.

In yet further embodiments, the process 1000 can determine if the confidence metric satisfies a precision condition (block 1045). If the precision condition is met, the process 1000 can activate first transmission mode (block 1050). However, if the precision condition is not met, the process 1000 can activate second transmission mode (block 1060). This branching logic ensures that the high-energy radio is only used when the data quality or security situation justifies the cost. For example, if the system is 90% sure the asset is moving unauthorized, it triggers the precision mode; if it is only 40% sure, it defaults to the lower power mode to save energy while continuing to monitor.

In yet additional embodiments, the process 1000 can activate first transmission mode (block 1050). In various embodiments, this involves powering up a high-bandwidth or high-precision radio, such as an Ultra-Wideband (UWB) transceiver, to perform accurate ranging. For example, the tag might initiate a two-way ranging exchange with nearby anchors to determine its position within centimeters. In some embodiments, this mode involves increasing the transmission rate of standard advertising packets to provide near real-time updates. For instance, the tag might switch from sending a BLE beacon every 5 seconds to every one-hundred milliseconds to facilitate real-time wayfinding.

In various embodiments, the process 1000 can activate second transmission mode (block 1060). In some embodiments, this utilizes a low-power radio technology, such as Bluetooth Low Energy (BLE) or Zigbee, to send basic status updates. For example, the tag might simply broadcast its ID and a “moving” flag without attempting to calculate a precise location. In other embodiments, this mode involves sending data packets only when a new, distinct motion event is detected, rather than continuously streaming data. For instance, the device might send a single “start of motion” packet and then go silent until the motion stops, relying on the infrastructure to estimate the path in between.

Although a specific embodiment for a process 1000 for dynamic power and sensor management suitable for carrying out the various steps, processes, methods, and operations described herein is discussed with respect to FIG. 10, any of a variety of systems and/or processes may be utilized in accordance with embodiments of the disclosure. For example, the power metric monitoring could trigger a complete shutdown of non-essential subsystems, rather than just modifying sampling parameters, in extreme low-battery scenarios. The elements depicted in FIG. 10 may also be interchangeable with other elements of FIGS. 1-9 and 11-15 as required to realize a particularly desired embodiment.

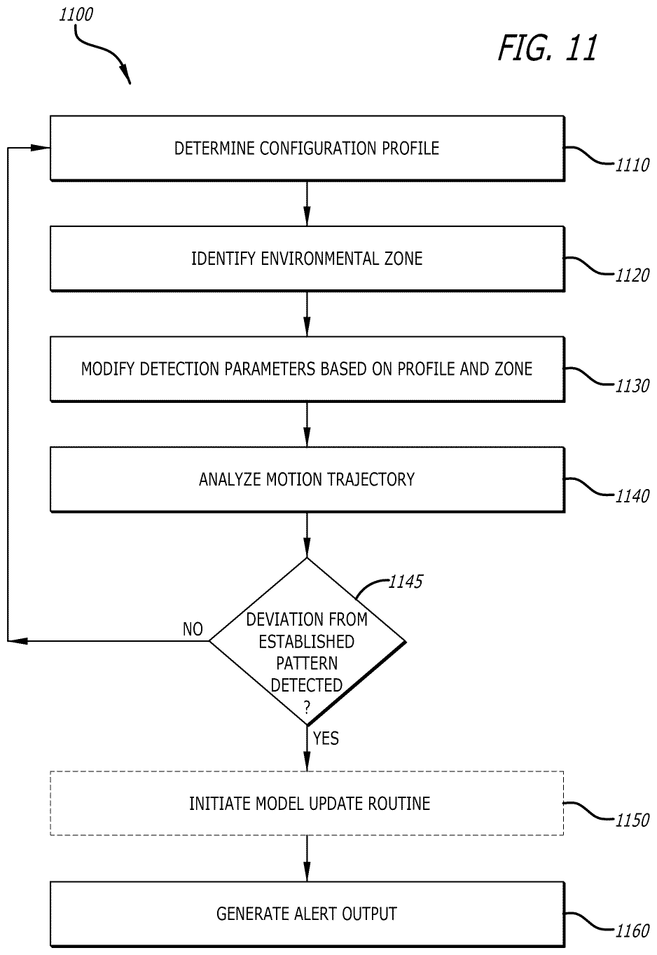

Referring to FIG. 11, a flowchart depicting a process 1100 for context-aware tracking and configuration profile determination in accordance with various embodiments of the disclosure is shown. In many embodiments, the process 1100 can determine configuration profile (block 1110). In some embodiments, this determination involves querying a local storage lookup table using a unique asset identifier to retrieve specific handling instructions associated with the attached equipment type. For example, a profile for a “glass vial” might specify extremely low vibration tolerance, whereas a profile for a “steel beam” might allow for significant impact without triggering a state change. In other embodiments, the configuration profile is dynamically received from a central server upon initial activation or during a provisioning handshake. For instance, a technician might use a handheld scanner to push a specific profile to the tag based on the current assignment of the asset.

In further embodiments, the process 1100 can identify environmental zone (block 1120). In various embodiments, this identification is achieved by scanning for unique zone identifiers broadcast by fixed infrastructure anchors within the facility. For example, the device might detect a specific Bluetooth Low Energy (BLE) beacon UUID that corresponds to a “Cold Storage” zone or a “Loading Dock” zone. In additional embodiments, the identification relies on signal strength triangulation or time-of-flight ranging to determine the precise geospatial coordinates of the device relative to a digital map. For instance, the logic might calculate that the device is currently located within the geofenced boundaries of a high-security server room.

In additional embodiments, the process 1100 can modify detection parameters based on profile and zone (block 1130). In some embodiments, this modification entails calculating a composite sensitivity threshold that accounts for both the inherent fragility of the asset and the expected activity level of the current location. For example, if a fragile asset is in a known high-vibration transport zone, the system might temporarily desensitize the alert trigger to prevent a flood of false positive alarms. In other embodiments, the modification involves enabling or disabling specific sensor axes or sampling rates to align with the context. For instance, if the asset is in a “Stationary Storage” zone, the sampling rate might be reduced to a minimum heartbeat frequency to conserve energy while still monitoring for unauthorized removal.

In still more embodiments, the process 1100 can analyze motion trajectory (block 1140). In certain embodiments, this analysis involves buffering a sequence of location points or accelerometer vectors to construct a historical path of movement over a defined window of time. For example, the logic might track the heading and speed of the asset to determine if it is moving along a recognized corridor or diverting into an unauthorized area. In various embodiments, the analysis includes comparing the current movement vector against a library of learned or pre-programmed standard routes. For instance, the system might verify if the asset is following the standard delivery route from the warehouse to the production floor.

In specific embodiments, the asset monitoring logic utilizes the collected motion data, which may potentially include the reconstructed data points generated via interpolation, to construct a comprehensive motion trajectory that represents the directional path or vector of the movement of the asset over time. Once this motion trajectory is defined based on the determined motion state, the logic acts to transmit the trajectory data payload via the currently activated transmission mode, such as the high-precision mode or the low-power mode, to the network infrastructure. This transmission mechanism allows the backend system to visualize the specific route and velocity vector taken by the asset, rather than just receiving discrete and unconnected location pings. Furthermore, by transmitting the full trajectory, the system can enable downstream analytics engines to predict future destinations or identify complex movement patterns that correlate with specific workflow activities.

In yet further embodiments, the process 1100 can determine if deviation from established pattern detected (block 1145). If no deviation from established pattern is detected, then the process 1100 can once again determine configuration profile (block 1110). In this scenario, the system continues its monitoring loop, constantly re-evaluating the context as the asset moves or conditions change. However, if deviation from established pattern detected is true, then the process 1100 can initiate model update routine (block 1150). This branching logic ensures that corrective actions or alerts are only triggered when the asset's behavior falls outside the acceptable parameters defined by the combination of its profile and zone.

In some embodiments, the process 1100 can initiate model update routine (block 1150). In various embodiments, this step triggers a machine learning feedback loop where the detected deviation is recorded and analyzed to determine if it represents a new normal behavior pattern. For example, if a specific route deviation occurs frequently without negative consequences, the model might effectively “learn” this new path as a valid trajectory for future reference. In other embodiments, this routine involves communicating with a central server to request an updated set of weights or parameters for the onboard inference engine. For instance, the device might upload the deviation data and receive a refined configuration profile in return that better accounts for the new environmental conditions.

In yet additional embodiments, the process 1100 can generate alert output (block 1160). In many embodiments, this generation involves transmitting a high-priority interrupt packet to the network infrastructure detailing the nature of the deviation and the current location of the asset. For example, the tag might send a “Security Breach” message via Ultra-Wideband (UWB) to the nearest anchor to ensure immediate notification of security personnel. In other embodiments, the alert output triggers local indicators on the device itself, such as an audible buzzer or a flashing LED array. For instance, the device might beep loudly to warn the user that they are taking the asset into a restricted zone, allowing them to correct the action immediately.

Although a specific embodiment for a process 1100 for context-aware tracking and configuration profile determination suitable for carrying out the various steps, processes, methods, and operations described herein is discussed with respect to FIG. 11, any of a variety of systems and/or processes may be utilized in accordance with embodiments of the disclosure. For example, the identification of the environmental zone could be performed by a separate backend server which then pushes the modified parameters to the device, rather than the device determining the zone locally. The elements depicted in FIG. 11 may also be interchangeable with other elements of FIGS. 1-10 and 12-15 as required to realize a particularly desired embodiment.

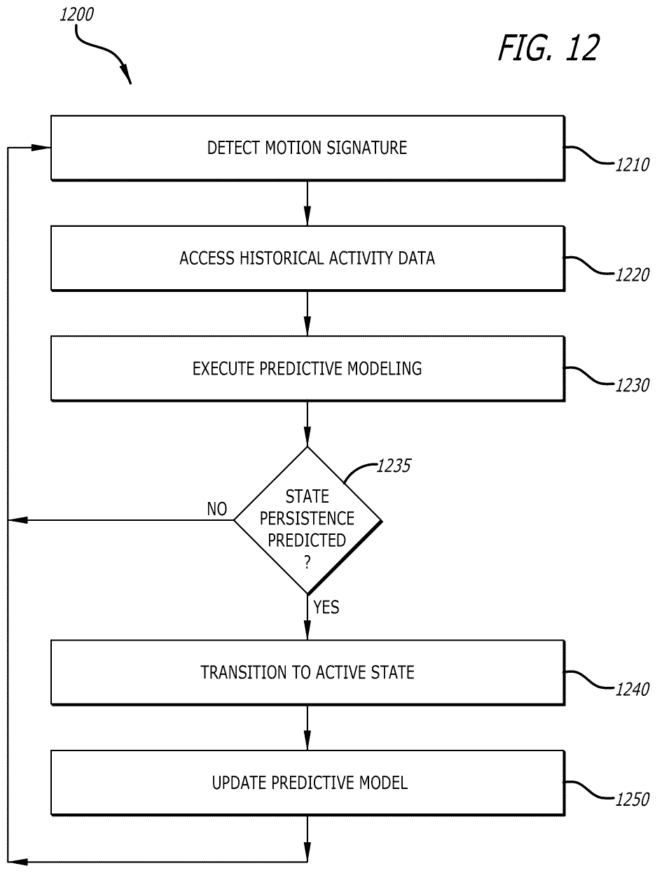

Referring to FIG. 12, a flowchart depicting a process 1200 for predictive state transitioning based on motion signatures and historical data in accordance with various embodiments of the disclosure is shown. In many embodiments, the process 1200 can detect motion signature (block 1210). In some embodiments, this detection involves analyzing the raw accelerometer data stream to identify specific frequency components or amplitude patterns that correspond to known mechanical interactions. For example, the logic might recognize the rhythmic, low-frequency oscillation characteristic of a forklift engine or the smooth, continuous vibration of a conveyor belt as distinct from random handling noise. In other embodiments, detecting the signature involves aggregating sensor readings over a short time window to calculate statistical features such as variance, skewness, or kurtosis. For instance, the system might identify a high-variance, chaotic signature indicative of a manual carry event versus a low-variance signature indicative of a rolling cart transport.

In further embodiments, the process 1200 can access historical activity data (block 1220). In various embodiments, this step entails retrieving a log of recent state transitions or sensor events stored in a circular buffer within the device's local memory. For example, the system might review the last ten minutes of data to see if the asset has frequently started and stopped moving, suggesting an intermittent usage pattern typical of a picking workflow. In additional embodiments, accessing the data involves referencing a longer-term usage profile that correlates activity with temporal factors such as time of day or shift schedules. For instance, the process might determine that motion detected at a specific time of morning typically lasts for at least an hour based on data collected over the previous month.

In additional embodiments, the process 1200 can execute predictive modeling (block 1230). In some embodiments, this execution utilizes a probabilistic algorithm, such as a Markov chain or Bayesian inference model, to calculate the likelihood of the current motion state continuing into the immediate future. For example, if the asset is currently classified as being on a forklift, the model might calculate a 95% probability that the motion will persist for several minutes based on the known average duration of forklift trips. In other embodiments, the modeling involves a simpler heuristic or rule-based projection that extrapolates the current trajectory to estimate a future destination or state duration. For instance, if the asset is moving at a constant velocity down a long corridor, the model predicts that the “moving” state will persist until the asset reaches the end of the hallway.

In still more embodiments, the process 1200 can determine if state persistence predicted (block 1235). If state persistence is not predicted, then the process 1200 can once again detect motion signature (block 1210). In this scenario, the system determines that the current motion is likely transient or insignificant, and therefore returns to its monitoring loop without altering the primary power state or radio configuration. However, if state persistence is predicted, then the process 1200 can transition to active state (block 1240). This predictive determination allows the device to preemptively wake up fully or engage higher-power resources before a critical tracking gap occurs, ensuring continuous visibility during significant events.

In yet further embodiments, the process 1200 can transition to active state (block 1240). In many embodiments, this transition involves waking up the primary communication radio, such as an Ultra-Wideband (UWB) transceiver, from a deep sleep mode to prepare for continuous ranging operations. For example, anticipating that a transport event will last ten minutes, the device switches to a high-frequency update rate immediately rather than waiting for a specific displacement threshold to be crossed. In other embodiments, the transition entails locking the current sensor configuration to a high-sensitivity profile to ensure that no details of the predicted movement are lost. For instance, the logic might enable full 3-axis logging to capture the orientation of the asset during the predicted transport phase.

In some embodiments, the process 1200 can update predictive model (block 1250). In various embodiments, this update involves feeding the actual outcome of the motion event back into the probability weights of the onboard algorithm to refine future predictions. For example, if a predicted “long transport” event ended prematurely, the model adjusts its parameters to be more conservative in future predictions of state persistence to save power. In additional embodiments, the update includes synchronizing local learning weights with a global model provided by a central server to benefit from fleet-wide data. For instance, the device might download a new set of transition probabilities derived from the aggregate behavior of thousands of similar assets in the facility.

Although a specific embodiment for a process 1200 for predictive state transitioning based on motion signatures and historical data suitable for carrying out the various steps, processes, methods, and operations described herein is discussed with respect to FIG. 12, any of a variety of systems and/or processes may be utilized in accordance with embodiments of the disclosure. For example, the predictive modeling could be performed entirely in the cloud, with the device simply uploading the signature and receiving a transition command in response. The elements depicted in FIG. 12 may also be interchangeable with other elements of FIGS. 1-11 and 13-15 as required to realize a particularly desired embodiment.

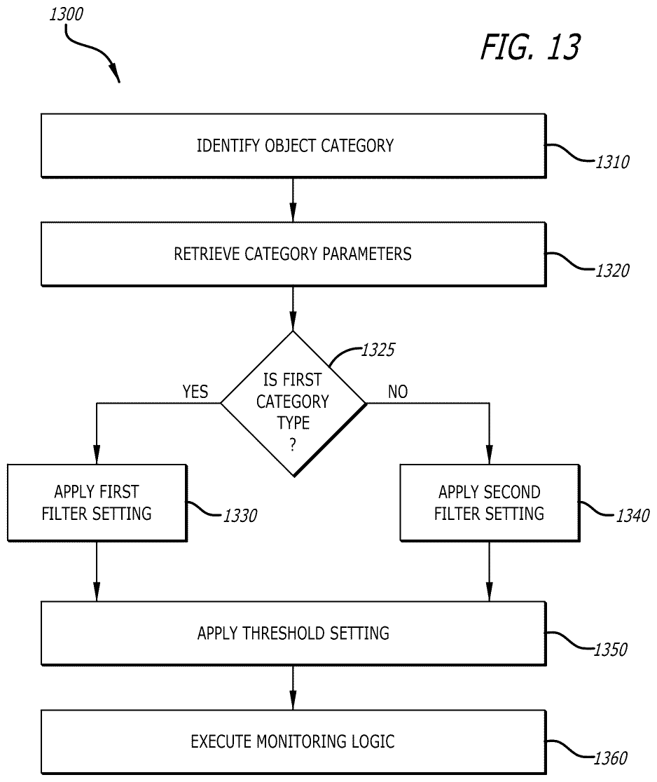

Referring to FIG. 13, a flowchart depicting a process 1300 for applying configuration-based filters based on identified object categories in accordance with various embodiments of the disclosure is shown. In many embodiments, the process 1300 can identify object category (block 1310). In some embodiments, this identification involves reading a specific configuration byte or asset type identifier programmed into the tag's non-volatile memory during provisioning. For example, a “Type 1” identifier might correspond to a wheelchair, while a “Type 2” identifier corresponds to an infusion pump. In other embodiments, the identification is inferred dynamically by analyzing the unique vibration signature or movement pattern of the asset over a learning period. For instance, the system might recognize the characteristic resonance of a heavy generator and automatically assign it to a “Heavy Machinery” category without manual input.

In further embodiments, the process 1300 can retrieve category parameters (block 1320). In various embodiments, this step entails loading a specific set of filtering coefficients, threshold values, and monitoring rules from an onboard library that corresponds to the identified object category. For example, if the category is “Fragile Electronics,” the system loads a high-sensitivity shock detection profile. In additional embodiments, the parameters are fetched from a remote server or a local gateway during a periodic synchronization window to ensure the tag is using the latest definitions. For instance, a fleet-wide update might push new “Low Vibration” parameters for all carts to reduce false positives from uneven flooring.

In additional embodiments, the process 1300 can determine if is first category type (block 1325). If is first category type is true, then the process 1300 can apply first filter setting (block 1330). However, if is first category type is not true (implying it is a second or other category), then the process 1300 can apply second filter setting (block 1340). This branching logic allows the single hardware device to adapt its behavior to widely divergent asset types. For example, a “forklift” (first category) requires a filter that ignores engine rumble, whereas a “server rack” (second category) requires a filter that detects even the slightest seismic activity or unauthorized tilt.

In still more embodiments, the process 1300 can apply threshold setting (block 1350). In some embodiments, this application sets the specific magnitude or duration of motion required to trigger an alert or wake-up event, based on the selected filter path. For example, the threshold for the forklift might be set to 2G to ignore normal driving bumps, while the threshold for the server rack is set to 0.1G. In other embodiments, the threshold setting includes defining a “time-to-trigger” parameter, ensuring that brief, transient shocks do not cause a state change unless they sustain for a specific duration. For instance, a 5-millisecond shock might be ignored, but a 500-millisecond vibration triggers a “moving” state.

In yet further embodiments, the process 1300 can execute monitoring logic (block 1360). In many embodiments, this execution involves running the main sensor polling loop using the newly applied filters and thresholds to monitor for significant events. For example, the tag continuously samples the accelerometer, passes the raw data through the selected high-pass or low-pass filter, and compares the result against the active threshold. In additional embodiments, the monitoring logic includes logging any events that cross the threshold into a local history buffer for later upload. For instance, the system records a timestamp and peak G-force value every time the “Heavy Machinery” vibration limit is exceeded to help diagnosis potential mechanical failures.

Although a specific embodiment for a process 1300 for applying configuration-based filters based on identified object categories suitable for carrying out the various steps, processes, methods, and operations described herein is discussed with respect to FIG. 13, any of a variety of systems and/or processes may be utilized in accordance with embodiments of the disclosure. For example, the process could support an arbitrary number of categories rather than just two, utilizing a lookup table or switch-case structure to select from dozens of potential filter profiles. The elements depicted in FIG. 13 may also be interchangeable with other elements of FIGS. 1-12 and 14-15 as required to realize a particularly desired embodiment.

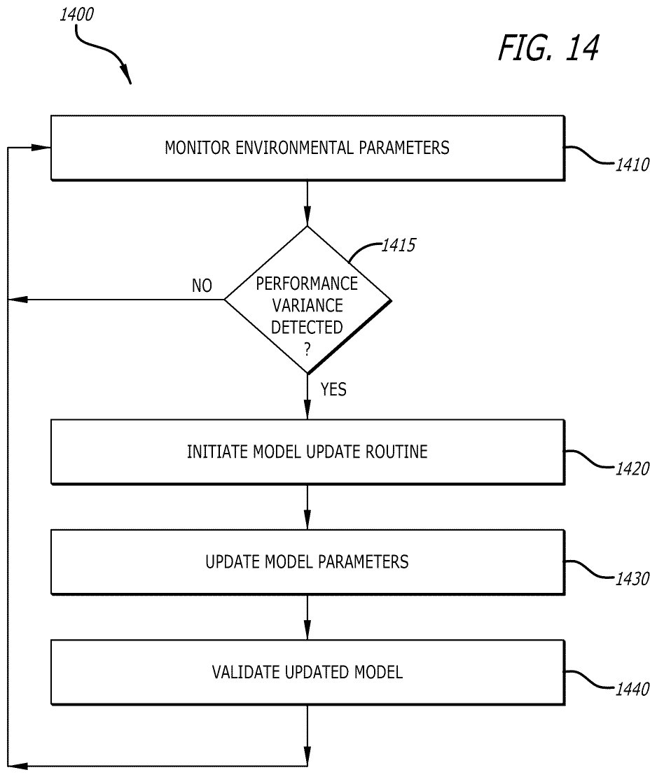

Referring to FIG. 14, a flowchart depicting a process 1400 for automated model refinement and environmental parameter monitoring in accordance with various embodiments of the disclosure is shown. In many embodiments, the process 1400 can monitor environmental parameters (block 1410). In some embodiments, this monitoring involves continuously sensing ambient conditions such as temperature, humidity, or magnetic interference that might affect sensor baseline readings. For example, the system might track the operating temperature to compensate for drift in the accelerometer's zero-g offset or bias caused by thermal expansion. In other embodiments, the monitoring includes tracking the statistical distribution of “noise” vibrations to detect if the deployment environment has fundamentally changed. For instance, the logic might detect that the device has moved from a quiet storage room to a vibrating active server rack, changing the baseline noise floor significantly.

In further embodiments, the process 1400 can determine if performance variance detected (block 1415). If performance variance detected is not true, then the process 1400 can once again monitor environmental parameters (block 1410). In this scenario, the system assumes the current model parameters are still valid and effective for the current environment, requiring no intervention or retraining. However, if performance variance detected is true, then the process 1400 can initiate model update routine (block 1420). This detection might be triggered by an increase in false positive alerts, a decrease in classification confidence scores below a recognizable baseline, or a sudden shift in the frequency spectrum of the sensor data.

In additional embodiments, the process 1400 can initiate model update routine (block 1420). In some embodiments, this initiation triggers a localized meta-learning algorithm, such as Model-Agnostic Meta-Learning (MAML), designed to rapidly adapt the inference engine to new tasks with minimal data. For example, the device might enter a calibration mode where it collects a new batch of sample data to serve as a support set for the adaptation process. In other embodiments, the routine involves flagging the variance to a central server and requesting a “fine-tuning” package that is specifically optimized for the new environmental conditions detected. For instance, the tag might request a firmware patch containing new filter coefficients suited for a high-temperature environment.

In still more embodiments, the process 1400 can update model parameters (block 1430). In various embodiments, this update involves adjusting the weights and biases of the neural network layers stored in the device's flash memory. For example, the bias of the input layer might be shifted to account for a permanent tilt in the mounting position of the asset tag that was previously interpreted as motion. In additional embodiments, the update entails modifying the decision thresholds of a random forest or decision tree model to reduce sensitivity to a newly identified noise frequency. For instance, the system might increase the activation threshold for the “impact” class if the background vibration level has consistently increased.

In yet further embodiments, the process 1400 can validate updated model (block 1440). In many embodiments, this validation is performed by running the updated model against a held-out validation dataset collected during the initiation phase to ensure accuracy has improved. For example, the system might check that the False Acceptance Rate (FAR) for vibration noise has dropped below a specific percentage before committing the changes. In other embodiments, the validation involves a “shadow mode” where the new model runs in parallel with the old model for a period of time to confirm stability before fully taking over control of the transmission triggers. For instance, the device confirms that the new parameters do not cause excessive battery drain due to frequent false wakeups.

Although a specific embodiment for a process 1400 for automated model refinement and environmental parameter monitoring suitable for carrying out the various steps, processes, methods, and operations described herein is discussed with respect to FIG. 14, any of a variety of systems and/or processes may be utilized in accordance with embodiments of the disclosure. For example, the validation step could be performed by a human administrator who reviews the performance data on a dashboard before authorizing the update to be applied permanently. The elements depicted in FIG. 14 may also be interchangeable with other elements of FIGS. 1-13 and 15 as required to realize a particularly desired embodiment.

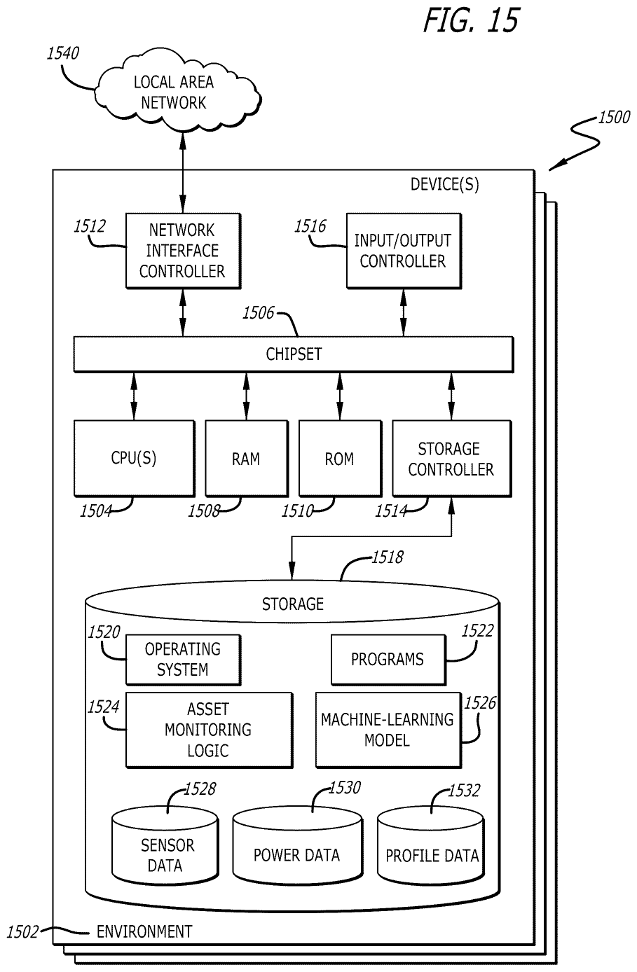

Referring to FIG. 15, a conceptual block illustration for a device suitable for configuration with an asset monitoring logic 1524 in accordance with various embodiments of the disclosure is shown. The embodiment of the conceptual block illustration depicted in FIG. 15 can illustrate a conventional network device, personal computer, mobile device, server, laptop, tablet, network appliance, e-reader, smartphone, wearable device, or other computing device, and can be utilized to execute any of the application and/or logic components presented herein. The device 1500 may, in many non-limiting examples, correspond to physical devices or to virtual resources described herein.

In many embodiments, the device 1500 may include an environment 1502 such as a baseboard or “motherboard,” in physical embodiments that can be configured as a printed circuit board with a multitude of components or devices connected by way of a system bus or other electrical communication paths. Conceptually, in virtualized embodiments, the environment 1502 may be a virtual environment that encompasses and executes the remaining components and resources of the device 1500. In more embodiments, the processor(s) 1504, such as, but not limited to, central processing units (“CPUs”) can be configured to operate in conjunction with a chipset 1506. The processor(s) 1504 can be standard programmable CPUs that perform arithmetic and logical operations necessary for the operation of the device 1500.

In a number of embodiments, the processor(s) 1504 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 1506 may provide an interface between the processor(s) 1504 and the remainder of the components and devices within the environment 1502. The device 1500 can incorporate different types of processors to enhance performance and efficiency across various tasks. A central processing unit (CPU) can handle primary processing tasks such as general logics, AI, and other inputs, while a graphics processing unit (GPU) can be specialized for various compute and inference tasks. Digital signal processors (DSPs) may manage audio processing, delivering high-quality sound without burdening the CPU. In portable devices, systems on a chip (SoCs) can be configured to integrate the CPU, GPU, memory, and peripherals to balance performance and efficiency. In some embodiments, application-specific integrated circuits (ASICs) can optimize specific functions like cryptographic processing, while neural processing units (NPUs) accelerate AI and machine learning tasks. Some high-end devices may also include physics processing units (PPUs) to handle complex physics calculations. However, those skilled in the art will recognize that the device 1500 can any variety or combination of processor(s) 1504 as needed to satisfy the desired application.

The chipset 1506 can provide an interface to a random-access memory (“RAM”) 1508, which can be used as the main memory in the device 1500 in some embodiments. The chipset 1506 can further be configured to provide an interface to a computer-readable storage medium such as a read-only memory (ROM 1510) or non-volatile RAM (“NVRAM”) for storing basic routines that can help with various tasks such as, but not limited to, starting up the device 1500 and/or transferring information between the various components and devices. The ROM 1510 or NVRAM can also store other application components necessary for the operation of the device 1500 in accordance with various embodiments described herein.

Additional embodiments of the device 1500 can be configured to operate in a networked environment using logical connections to remote computing devices and computer systems through a network, such as the local area network 1540. The chipset 1506 can include functionality for providing network connectivity through a network interface controller (NIC 1512), which may comprise a gigabit Ethernet adapter or similar component. The NIC 1512 can be capable of connecting the device 1500 to other devices over the local area network 1540. It is contemplated that a NIC 1512 or multiple may be present in the device 1500, connecting the device to other types of networks and remote systems, such as the Internet.

In further embodiments, the device 1500 can be connected to a storage 1518 that provides non-volatile storage for data accessible by the device 1500. The storage 1518 can, for instance, store an operating system 1520, and/or programs 1522. In various embodiments, the storage 1518 can be connected to the environment 1502 through a storage controller 1514 connected to the chipset 1506. In certain embodiments, the storage 1518 can consist of one or more physical storage units. The storage controller 1514 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

In additional embodiments, the device 1500 can store data within the storage 1518 by transforming the physical state of the physical storage units to reflect the information being stored. The specific transformation of physical state can depend on various factors. Examples of such factors can include, but are not limited to, the technology used to implement the physical storage units, whether the storage 1518 is characterized as primary or secondary storage, and the like.

In addition to the storage 1518 described above, certain embodiments of the device 1500 may also have access to other computer-readable storage media to store and retrieve information, such as program modules, data structures, or other data. It should be appreciated by those skilled in the art that computer-readable storage media is any available media that provides for the non-transitory storage of data and that can be accessed by the device 1500. In some examples, operations performed by a cloud computing network, and or any components included therein, may be supported by one or more devices similar to device 1500. Stated otherwise, some or all of the operations performed by the cloud computing network, and or any components included therein, may be performed by a device 1500 or multiple operating in a cloud-based arrangement.

By way of example, and not limitation, computer-readable storage media can include volatile and non-volatile, removable and non-removable media implemented in any method or technology. Computer-readable storage media includes, but is not limited to,

RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 1518 can store an operating system 1520 utilized to control the operation of the device 1500. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized.

The storage 1518 can store other system or application programs and data utilized by the device 1500. In many additional embodiments, the storage 1518 or other computer-readable-storage media is encoded with computer-executable instructions which, when loaded into the device 1500, may transform it from a general-purpose computing system into a special-purpose computer capable of implementing the embodiments described herein. These computer-executable instructions may be stored as application and transform the device 1500 by specifying how the processor(s) 1504 can transition between states, as described above.

In some embodiments, the device 1500 has access to computer-readable storage media storing computer-executable instructions which, when executed by the device 1500, perform the various processes described herein. In certain embodiments, the device 1500 can also include computer-readable storage media having instructions stored thereupon for performing any of the other computer-implemented operations described herein.

In many embodiments, the asset monitoring logic 1524 may be configured to provide the primary operational intelligence for the device 1500. This logic can be executed by the processor(s) 1504 and can be configured to carry out the processes described herein. For instance, the asset monitoring logic 1524 can be responsible for processing raw input from the onboard sensors to detect motion signatures or environmental changes. This asset monitoring logic 1524 can then pass these inputs to a local inference engine, which may utilize one of the machine-learning model(s) 1526.

In further embodiments, the asset monitoring logic 1524 can be configured to receive a classification output from the machine-learning model. This output may be compared against thresholds retrieved from the profile data 1532. Upon determining that a significant event has occurred, the asset monitoring logic 1524 can instruct the NIC 1512 to wake up a specific radio and transmit an alert. This logic may also be configured to manage the device's power states, dynamically adjusting sensor sampling rates based on the current battery level stored in the power data 1530.

In a number of embodiments, the storage 1518 can be configured to store sensor data 1528. This data can represent the raw or processed readings captured by the device's sensors, such as accelerometer vectors or temperature logs. The sensor data 1528 can store a historical buffer of measurements, which may be used for retrospective analysis or predictive modeling. This data can be accessed by the asset monitoring logic 1524 to determine if a motion pattern persists over time or if an environmental threshold has been breached.

In additional embodiments, the sensor data 1528 can be generated and updated continuously as the device operates in its monitoring state. This data may be compressed or filtered before storage to optimize memory usage. The sensor data 1528 may be a circular buffer, overwriting the oldest entries with new measurements, or it may be uploaded to a central server during scheduled synchronization windows to clear space for new recordings.

In more embodiments, the storage 1518 may also store power data 1530. This data can include the current state of charge of the battery, estimated remaining runtime, and historical power consumption metrics. For example, the power data 1530 may store logs of how much energy was consumed by recent radio transmissions or sensor polling cycles. This data may be used by the asset monitoring logic 1524 to make intelligent decisions about whether to enter a power-saving mode or reduce the frequency of location updates.

In still more embodiments, the storage 1518 can be configured to store profile data 1532. This data can include the specific configuration parameters that dictate the device's behavior based on the asset type or environmental zone. The profile data 1532 may store sensitivity thresholds for motion detection, preferred transmission intervals, and radio wake-up triggers. This data can be utilized by the asset monitoring logic 1524 to tailor the monitoring strategy to the specific context of the deployment.

In many embodiments, the thresholds utilized by the asset monitoring logic are not merely static values but can be determined dynamically based on a variety of operational factors. For example, a threshold might be initially set to a predetermined factory default but is subsequently adjusted based on the specific asset category or environmental zone identified by the device. In some embodiments, the thresholds are determined through a machine learning process that analyzes historical vibration data to establish a baseline noise floor for specific locations, ensuring that alerts are only generated for statistically significant deviations. Furthermore, various embodiments utilize one or more predetermined thresholds that are defined by system administrators and pushed to the device during provisioning, allowing for granular control over sensitivity based on organizational security policies. These thresholds can be configured as multi-stage triggers, wherein a first lower threshold triggers a local data logging event to conserve power, while a second higher threshold triggers an immediate high-priority transmission via the network interface.

In yet further embodiments, the profile data 1532 can also store the rules for switching between different operational profiles. For instance, this data may store the logic for determining when to switch from a “transport” profile to a “stationary” profile based on the duration of inactivity. This data can be configurable to allow an administrator to push new policies to the device over the air, ensuring that the asset tracking behavior remains aligned with organizational security and operational requirements.

In various embodiments, the storage 1518 can also store one or more machine-learning model(s) 1526. These models can include the trained neural networks or decision trees used for on-device inference. For instance, the machine-learning model(s) 1526 may include a lightweight decision tree for initial motion classification and a more complex neural network for detailed event analysis. These machine-learning model(s) 1526 may be updated periodically via firmware over-the-air (FOTA) updates to improve accuracy or adapt to new types of assets.

In certain embodiments, the machine-learning model(s) 1526 may also include anomaly detection algorithms that learn the normal behavior patterns of the specific asset over time. In such an embodiment, the model runs locally on the processor(s) 1504 to flag deviations without needing constant cloud connectivity. In other embodiments, the machine-learning model(s) 1526 may include “meta-learning” components that allow the device to quickly adapt its parameters to new environmental conditions based on limited new data samples.

In still further embodiments, the device 1500 can also include one or more input/output controllers 1516 for receiving and processing input from a number of input devices, such as a keyboard, a mouse, a touchpad, a touch screen, an electronic stylus, or other type of input device. Similarly, input/output controllers 1516 can be configured to provide output to a display, such as a computer monitor, a flat panel display, a digital projector, a printer, or other type of output device.

Those skilled in the art will recognize that the device 1500 might not include all of the components shown in FIG. 15 and can include other components that are not explicitly shown or might utilize an architecture completely different than that shown in. As described above, the device 1500 may support a virtualization layer, such as one or more virtual resources executing on the device 1500. In some examples, the virtualization layer may be supported by a hypervisor that provides one or more virtual machines running on the device 1500 to perform functions described herein. The virtualization layer may generally support a virtual resource that performs at least a portion of the techniques described herein.

Although a specific embodiment for a conceptual block illustration for a device suitable for configuration with an asset monitoring logic 1524 suitable for carrying out the various steps, processes, methods, and operations described herein is discussed with respect to FIG. 15, any of a variety of systems and/or devices may be utilized in accordance with embodiments of the disclosure. For example, the asset monitoring logic 1524 could be executed within a distributed cloud computing environment rather than a single physical device. It is contemplated that the elements depicted in FIG. 15 may also be interchangeable with other elements or combined in various ways as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. An asset tracking device, comprising:
a processor;
a motion sensor configured to capture motion data;
a network interface; and
a memory communicatively coupled to the processor, wherein the memory comprises an asset monitoring logic that is configured to:
monitor a power metric associated with the asset tracking device;
modify a sensor sampling parameter based on the power metric;
determine a confidence metric associated with a motion state of the asset tracking device based on the motion data; and
activate a transmission mode based on the confidence metric satisfying a precision condition.

2. The asset tracking device of claim 1, wherein the network interface is configured to provide communication via a plurality of transmission modes.

3. The asset tracking device of claim 2, wherein the activated transmission mode is selected from the plurality of transmission modes.

4. The asset tracking device of claim 2, wherein the network interface comprises a Bluetooth low energy (BLE) radio for low-power transmission mode.

5. The asset tracking device of claim 4, wherein the network interface further comprises an ultra-wideband (UWB) radio configured for a high-precision transmission mode.

6. The asset tracking device of claim 5, wherein the BLE radio is activated in response to the precision condition falling below a predetermined threshold.

7. The asset tracking device of claim 5, wherein the UWB radio is activated in response to the precision condition being satisfied.

8. The asset tracking device of claim 1, wherein the power metric is associated with a battery of the asset tracking device.

9. The asset tracking device of claim 8, wherein the sensor sampling parameter is associated with the motion sensor.

10. The asset tracking device of claim 9, wherein the modifying the sensor sampling parameter is based on satisfying one or more threshold conditions associated with the power metric.

11. The asset tracking device of claim 10, wherein the sensor sampling parameter is a sampling frequency of the motion sensor.

12. The asset tracking device of claim 11, wherein the sampling frequency of the motion sensor is reduced in response to the power metric associated with the battery falling below a predetermined threshold.

13. The asset tracking device of claim 12, wherein the asset monitoring logic is further configured to apply a linear interpolation algorithm to the motion data to reconstruct one or more gaps in the motion data resulting from the reduced sampling frequency.

14. The asset tracking device of claim 12, wherein the asset monitoring logic is further configured to transmit a motion trajectory via the activated transmission mode, wherein the motion trajectory is based on at least the motion state.

15. A network device, comprising:
a processor;
a network interface configured to communicate with a plurality of asset tracking devices; and
a memory communicatively coupled to the processor, wherein the memory comprises an asset monitoring logic that is configured to:
identify an environmental zone associated with an asset tracking device;
determine a configuration profile for the asset tracking device based on the environmental zone;
analyze a motion trajectory against the configuration profile; and
generate a notification in response to detecting a deviation from the configuration profile.

16. The network device of claim 15, wherein the environmental zone is associated with a current location of the asset tracking device.

17. The network device of claim 15, wherein the configuration profile defines a sensitivity threshold.

18. The network device of claim 15, wherein the motion trajectory is received from the asset tracking device.

19. The network device of claim 15, wherein the detection is based on an established pattern defined by the configuration profile.

20. A method of dynamic management of asset tracking devices, comprising:
monitoring, by an asset tracking device, a power metric associated with a battery of the asset tracking device;
modifying, by the asset tracking device, a sensor sampling parameter for a motion sensor based on the power metric satisfying a threshold condition;
determining, by the asset tracking device, a confidence metric associated with a motion state of the asset tracking device; and
activating, by the asset tracking device, a transmission mode selected from a plurality of transmission modes based on the confidence metric satisfying a precision condition.
